(19) United States
(12) Patent Application Publication
(10) Pub. No.: US 2025/0294309 A1
(43) Pub. Date: Sep. 18, 2025

(54) SOUND GENERATION CONTROL METHOD, SOUND PRODUCING DEVICE, AND SOUND GENERATION CONTROL PROGRAM

(71) Applicant: SONY GROUP CORPORATION, TOKYO (JP)

(72) Inventors: NATSUKO MAEDA, TOKYO (JP); NAOKI SHINMEN, TOKYO (JP); ATSUSHI YAMAMOTO, TOKYO (JP); YUJI NAKANISHI, TOKYO (JP); KAZUKI SAKAI, TOKYO (JP); KOYA SATO, TOKYO (JP); YUTA SATO, TOKYO (JP); HIROYUKI HONMA, TOKYO (JP)

(21) Appl. No.: 18/860,093

(22) PCT Filed: Apr. 21, 2023
(86) PCT No.: PCT/JP2023/015864

§ 371 Date: Oct. 25, 2024

(30) Foreign Application Priority Data
May 2, 2022 (JP) 2022-076215

(51) Int. Cl. H04S 7/00

(52) U.S. Cl. CPC H04S 7/305; H04S 2400/11

(57) ABSTRACT

A sound generation control method according to an aspect of the present disclosure includes causing a computer to execute receiving an input of environment data indicating each condition set in a virtual space in which a sound source and a sound reception point are arranged; selecting a plurality of solvers for calculating characteristics of a sound at the sound reception point in accordance with the environment data, and determining a first parameter to be input to each of the plurality of solvers; receiving a change request for a first sound signal generated based one the first parameter; and adjusting the environment data or the first parameter in response to the change request, and generating a second sound signal using the adjusted environment data or a second parameter that is the adjusted parameter and is newly input to each of the solvers.

### FIELD

The present disclosure relates to a sound generation control method, a sound producing device, and a sound generation control program.

### BACKGROUND

As virtual space technologies such as games, Metaverse, and Cross Reality (XR) develop, in order to enhance a sense of immersion of a user, realistic experience according to reality is also required for sound reproduced on a virtual space. In research for audibly recognizing a sounding body in a three-dimensional virtual space, there are many methods for simulating the sound production. Among them, a spatial sound field reproduction technique and the like using physical simulation are devised based on a physical phenomenon in a real space, and reproducibility is high in a case where sound is reproduced on a virtual space in terms of audibility.

Examples of the physical simulation method in a sound field include wave sound simulation that models and calculates wave characteristics of sound, and geometric sound simulation that geometrically models and calculates energy propagation of sound, typified by a sound ray method and a virtual image method. The former is known to well show microscopic wave phenomena, and is particularly advantageous for simulating low-frequency sounds greatly affected by diffraction, interference phenomena, and the like. However, since such a method discretizes a space and performs calculation, a calculation load is very large as compared with the geometric sound simulation, and it is difficult to perform real-time processing such as sound calculation following a player's line of sight in a game. On the other hand, in the latter, although the calculation algorithm is relatively simple and real time can be realized, application is limited to a high frequency band having a sufficiently short wavelength with respect to the dimension of the space because wave motion of sound such as diffraction and interference cannot be considered.

With regard to sound reproduction processing in the sound simulation, a method for reproducing a sound close to real hearing with a low calculation amount by separately calculating an early reflected sound and a high-order reflected sound (late reverberation sound) has been presented (for example, Patent Literature 1 below). Furthermore, a method for adjusting a ratio of the volume between the early reflected sound and the late reverberation sound according to the distance between the sound source and the user (listening point) has been proposed (for example, Patent Literature 2). In addition, a method is known in which a sound space is divided into areas in order to calculate a wave sound, and sound processing is performed between the divided boundaries to increase a calculation speed (for example, Non-Patent Literature 1). In addition, a deep learning method for deriving an expression for performing a calculation satisfying a physical rule using machine learning has also been proposed (for example, Non Patent Literature 2).

### CITATION LIST

### Patent Literature

Patent Literature 1: JP 2000-267675 A
Patent Literature 2: JP 2019-165845 A

### Non Patent Literature

Non Patent Literature 1: “Efficient and Accurate Sound Propagation Using Adaptive Rectangular Decomposition” N.Raghuvanshi et al., IEEE (2009)
Non Patent Literature 2: “Physics-informed neural networks: A deep learning framework for solving forward and inverse problems involving nonlinear partial differential equations” M. Raissi, P. Perdikaris, G. E. Karniadakis, Journal of Computational Physics 378 (2019)

### SUMMARY

### Technical Problem

According to the related art, sound reproducibility in the virtual space can be enhanced. The sound of the virtual space is set based on spatial object information or the like. However, in the related art, it is necessary for a content producer to set characteristics such as reflection parameters for each of the objects constituting the virtual space, and there is a large work load. In addition, in the related art, since the content producer cannot directly adjust the timbre, intuition is lacking in work, and it may be difficult to generate sound desired by the producer.

Furthermore, in content production, for example, parameter adjustment not necessarily in accordance with the physical rule may be performed in order to achieve the purpose of exaggerating a certain sound characteristic for production or, conversely, moderately expressing the sound characteristic. When a producer performs the parameter adjustment for these purposes, there is a problem that a correlation between parameters that should be physically followed for various generators for generating a sound signal collapses.

Therefore, the present disclosure proposes a sound generation control method, a sound producing device, and a sound generation control program capable of reducing the work load of the content producer and generating a consistent sound signal.

### Solution to Problem

A sound generation control method according to one embodiment of the present disclosure includes causing a computer to execute receiving an input of environment data indicating each condition set in a virtual space in which a sound source and a sound reception point are arranged; selecting a plurality of solvers for calculating characteristics of a sound at the sound reception point in accordance with the environment data, and determining a first parameter to be input to each of the plurality of solvers; receiving a change request for a first sound signal generated based one the first parameter; and adjusting the environment data or the first parameter in response to the change request, and generating a second sound signal using the adjusted environment data or a second parameter that is the adjusted parameter and is newly input to each of the solvers.

### BRIEF DESCRIPTION OF DRAWINGS

FIG. 1 is a diagram illustrating an outline of a sound generation control method according to an embodiment.

FIG. 2 is a diagram illustrating details of a sound simulator according to an embodiment.

FIG. 3 is a diagram illustrating a configuration example of a sound producing device according to an embodiment.

FIG. 4 is a diagram for explaining an outline of a sound simulation according to the embodiment.

FIG. 5 is a flowchart illustrating a flow of voice generation processing in the sound simulation.

FIG. 6 is a diagram (1) for explaining a user interface of the sound simulation according to the embodiment.

FIG. 7 is a diagram (2) for explaining a user interface of the sound simulation according to the embodiment.

FIG. 8 is a diagram (3) for explaining a user interface of the sound simulation according to the embodiment.

FIG. 9 is a flowchart (1) illustrating a flow of solver select processing in a sound simulation.

FIG. 10 is a diagram for explaining application of a diffracted sound solver.

FIG. 11 is a flowchart (2) illustrating the flow of solver select processing in the sound simulation.

FIG. 12 is a diagram (4) for explaining the user interface of the sound simulation according to the embodiment.

FIG. 13 is a diagram (5) for explaining the user interface of the sound simulation according to the embodiment.

FIG. 14 is a diagram for explaining parameters of each solver.

FIG. 15 is a diagram (6) for explaining the user interface of the sound simulation according to the embodiment.

FIG. 16 is a flowchart (1) illustrating an example of a flow of change processing according to the embodiment.

FIG. 17 is a diagram (7) for explaining the user interface of the sound simulation according to the embodiment.

FIG. 18 is a flowchart (2) illustrating an example of a flow of change processing according to the embodiment.

FIG. 19 is a flowchart (3) illustrating an example of a flow of change processing according to the embodiment.

FIG. 20 is a diagram (8) for explaining the user interface of the sound simulation according to the embodiment.

FIG. 21 is a diagram (9) for explaining the user interface of the sound simulation according to the embodiment.

FIG. 22 is a diagram for explaining an example of parameter control processing according to the embodiment.

FIG. 23 is a diagram illustrating an outline of a sound generation control method according to a modification.

FIG. 24 is a diagram illustrating an example of output control processing according to the modification.

FIG. 25 is a hardware configuration diagram illustrating an example of a computer that implements functions of the sound producing device.

### DESCRIPTION OF EMBODIMENTS

Hereinafter, embodiments of the present disclosure will be described in detail with reference to the drawings. In each of the following embodiments, the same parts are denoted by the same reference numerals, and redundant description will be omitted.

The present disclosure will be described according to the following order of items.
1. Embodiments
1-1. Outline of sound generation control method according to embodiment
1-2. Configuration of sound producing device according to embodiment
1-3. Outline of sound simulation according to embodiment
1-4. Adjustment of environment data (global data)
1-5. Learning processing by scene setting
1-6. Modification according to embodiment
2. Other embodiments
3. Effects of sound generation control method according to present disclosure
4. Hardware configuration

### 1. Embodiments

### 1-1. Outline of Sound Generation Control Method According to Embodiment

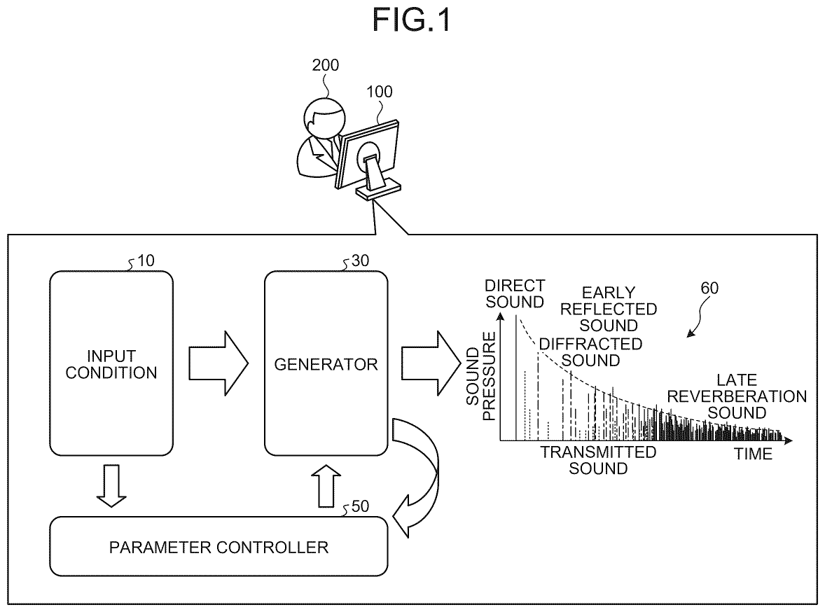

First, an outline of a sound generation control method according to an embodiment will be described with reference to FIG. 1. FIG. 1 is a diagram illustrating the outline of the sound generation control method according to the embodiment.

The sound generation control method according to the embodiment is executed by a sound producing device 100 illustrated in FIG. 1. The sound producing device 100 is an example of the sound producing device according to the present disclosure, and is an information processing terminal used by a producer 200 who produces content related to a virtual space, such as a game and a metaverse. For example, the sound producing device 100 is a personal computer (PC), a server device, a tablet terminal, or the like.

The sound producing device 100 includes an output unit such as a display and a speaker, and outputs various types of information to the producer 200. For example, the sound producing device 100 displays a user interface of software (for example, a sound simulator that generates a sound (sound signal) based on input information) related to sound production on a display. Furthermore, the sound producing device 100 outputs the generated sound signal from the speaker according to the operation instructed from the producer 200 on the user interface.

In the embodiment, the sound producing device 100 calculates as what kind of sound the sound output from the sound source object (hereinafter, referred to as a “sound source”) is reproduced at the listening point in a virtual three-dimensional space (hereinafter, the virtual space is referred to as a “virtual space”) such as a game, and reproduces the calculated sound. That is, the sound producing device 100 performs sound simulation in the virtual space, and performs processing of bringing a sound emitted in the virtual space close to the real world or reproducing a sound desired by the producer 200.

The virtual space in which the producer 200 intends to set the sound is displayed, for example, on a display included in the sound producing device 100. The producer 200 sets the position (coordinates) of the sound source (sound production point) in the virtual space and sets the sound reception point (a position at which a sound is observed in a virtual space, and is also referred to as a listening point). In a real space, a difference occurs between a sound observed near a sound source and a sound observed at a listening point due to various physical phenomena. Therefore, the sound producing device 100 virtually reproduces (simulates) a real physical phenomenon in the virtual space according to the instruction of the producer 200, and generates a sound signal suitable for the space so as to enhance the realistic feeling of the sound expression experienced in the virtual space by the game player or the like (hereinafter, referred to as a “user”) who uses the content.

The sound signal generated by the sound producing device 100 will be described. A graph 60 illustrated in FIG. 1 schematically illustrates the loudness of a sound when the sound emitted from the sound source is observed at a sound reception point. In a case where the sound reception point can be seen from the sound source, first, a direct sound is observed at the sound reception point, and thereafter, a diffracted sound, a transmitted sound, and the like of the direct sound are observed, and an early reflected sound reflected at the boundary of the virtual space is observed. The early reflected sound is observed each time the sound is reflected at the boundary, and for example, reflected sounds of first to third orders or reflected sounds reaching up to 80 ms after direct sound arrival are observed as the early reflected sound. Thereafter, a high-order reflected sound is observed as late reverberation sound at the sound reception point. Since the sound emitted from the sound source attenuates over time, the graph 60 draws an envelope (attenuation curve) asymptotically approaching 0 with the direct sound as a vertex.

The producer 200 designs the sound characteristics of the virtual space so that the sound emitted in the virtual space becomes a realistic sound with realistic feeling for the user who listens to the sound at the sound reception point. Specifically, the producer 200 designs sound characteristics of an object arranged in the virtual space and a boundary of the virtual space (corresponding to, for example, a wall or a ceiling of the virtual space).

Furthermore, the producer 200 may edit the sound signal illustrated in the graph 60 so that the sound output in the virtual space becomes an ideal sound. However, for example, in a case where the producer 200 changes only the late reverberation sound to an ideal sound, the late reverberation sound is observed after the direct sound, the diffracted sound, and the early reflected sound. Therefore, if the cooperation with the direct sound and the early reflected sound is not successful, an unnatural sound may be reproduced as a whole. That is, the entire sound signal such as the early reflected sound and the late reverberation sound of the virtual space is required to maintain an appropriate relationship close to a real physical phenomenon.

Furthermore, in order for the producer 200 to realize ideal sound characteristics in the virtual space, it is necessary to select various generators (referred to as solvers or the like) required for sound simulation, and to set parameters to be input to each generator. Such a setting work imposes a large work load on the producer 200 and hinders the progress of the work.

Therefore, the sound producing device 100 according to the present disclosure solves the above problem by the sound generation control method according to the embodiment. Specifically, the sound producing device 100 automatically selects a plurality of solvers to be used for generating the sound signal based on the data set in the virtual space, and then determines the parameters. Furthermore, in a case where the producer 200 changes an optional parameter, the sound producing device 100 automatically adjusts another parameter according to a predetermined physical rule based on a calculation to be described later, and newly generates a sound signal without unnaturalness as a whole. In other words, in a case where the change is made by the producer 200, the sound producing device 100 operates to make sense as a whole by adjusting other elements for generating the sound signal. As a result, the sound producing device 100 can reduce the work load of the producer 200 and generate a consistent sound signal.

FIG. 1 illustrates an outline of a flow of a sound generation control method according to an embodiment. FIG. 1 illustrates a flow in which the sound producing device 100 generates the sound signal shown in the graph 60.

The producer 200 uses the user interface provided from the sound producing device 100 to input an input condition 10 that is a condition in the virtual space in which the sound source and the sound reception point are arranged. The input condition 10 includes various types of data in the virtual space, such as objects and space data constituting the virtual space, sound characteristics such as transmittance and reflectance of the objects, positions of the sound source and the sound reception point, and loudness and directivity of a sound emitted from the sound source. Hereinafter, various types of data set as the input condition 10 may be collectively referred to as environment data.

When the input condition 10 is set, the sound producing device 100 generates a sound observed at the sound reception point based on the input condition 10. For example, the sound producing device 100 inputs the input condition 10 to a generator 30 and a parameter controller 50 for calculating (generating) components that determine the characteristics of the sound, such as early reflected sound and late reverberation sound, and generates the sound observed at the sound reception point (the sound signal corresponding to the graph 60 illustrated in FIG. 1). That is, the generator 30 can be said to be a calculator for sound simulation that inputs the output of input the input condition 10 and the parameter controller 50 and outputs a sound characteristic associated with each generator. As illustrated in FIG. 1, the producer 200 generates sound in which components (direct sound, early reflected sound, and the like) generated by the generator 30 are synthesized, and can reproduce a sound environment similar to the real space in the virtual space.

Note that the sound simulator provided by the sound producing device 100 includes a parameter controller 50 in addition to the generator 30 as illustrated in FIG. 1. The parameter controller 50 is a functional unit that controls parameters for controlling the generator 30 according to a predetermined physical rule.

The parameter controller 50 is a calculator that generates a parameter according to a predetermined physical rule, and for example, there may be a calculator based on an analytical solution by a theoretical formula or a wave sound simulator that correctly predicts a sound field in a three-dimensional space. That is, the parameter controller 50 functions to control parameters input to the various generators 30 based on the input condition 10, and for example, correlates the various generators according to the physical rule and automatically adjusts the parameters to appropriate parameters.

As described above, in content production, parameters conforming to the physical rule are not necessarily desired, and the producer 200 may exaggerate certain sound characteristics for production, or may express certain sound characteristics sparingly, for example. That is, after the sound is generated according to the input condition 10, the producer 200 may desire to change the sound in accordance with the intention to create the content created by the producer. As an example, the producer 200 changes parameters input to the generator 30 or changes the generator 30 itself to another generator. When parameter adjustment for these purposes is optionally performed, there is a concern that a correlation between parameters for various generators may collapse. For example, when the characteristics of the early reflected sound change, other characteristics should change accordingly in the case of the real sound, but other characteristics are maintained in the sound simulated on the virtual space.

On the other hand, in the sound generation control method according to the embodiment, the parameter controller 50 generates a new parameter or selects an appropriate generator so as to generate a sound signal that does not cause a sense of discomfort (does not contradict physical rules) in accordance with the intention of the producer 200. For example, when the producer 200 changes the early reflected sound of the sound, the parameter controller 50 reproduces the parameter input to another generator caused by the change according to the physical rule. As described above, in response to the change request from the producer 200 for the sound generated once, the sound producing device 100 performs feedback from the generator 30 to the parameter controller 50, and performs adjustment by the parameter controller 50. Then, the parameter controller 50 causes the generator 30 to calculate the characteristics for constituting the sound signal again using the reproduced parameter, thereby generating a sound that complies with a predetermined physical rule and does not cause a sense of discomfort. As a result, in a case where the producer 200 changes the early reflected sound, for example, it is possible to avoid generating a sound with a sense of discomfort as a whole or automatically adjusting the late reverberation sound manually so as to be consistent with the whole. That is, the producer 200 can reduce the adjustment load for realizing the sound environment intended by the producer by the function of the parameter controller 50.

Note that the above automatic adjustment is not necessarily limited to the re-adjustment of the parameters of the generator 30, and it is also possible to automatically correct the environment data input to the physical simulator, that is, the sound source position, the boundary condition of the object, and the like based on the change content. By reading the corrected environment data, the sound producing device 100 can further increase the correlation between the parameters of the generator 30 and reduce the work load on the producer 200.

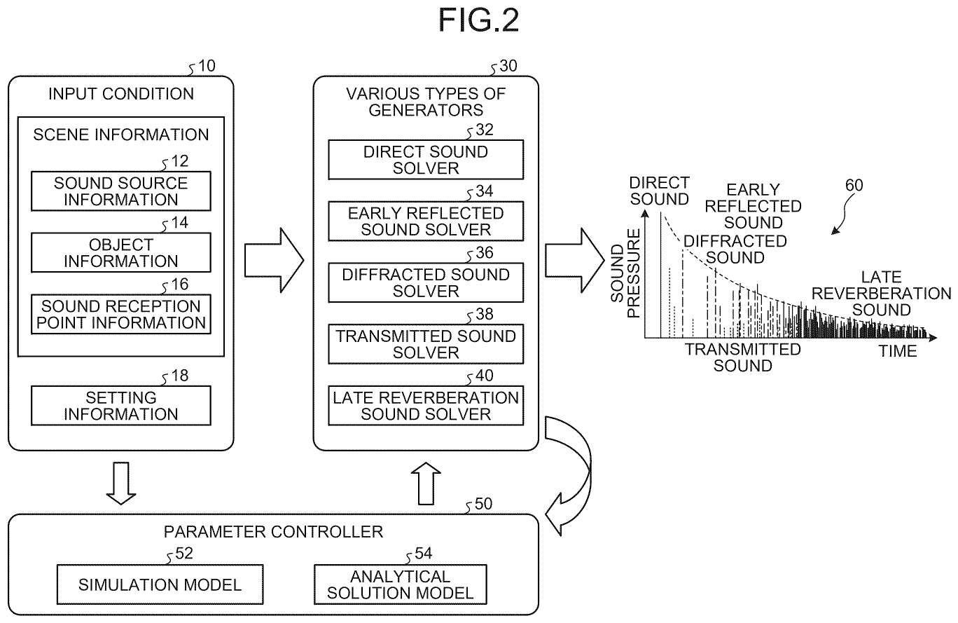

The sound generation processing executed by the sound producing device 100 will be described in more detail with reference to FIG. 2. FIG. 2 is a diagram illustrating details of the sound simulator according to the embodiment.

As illustrated in FIG. 2, the input condition 10 includes sound source information 12, object information 14, sound reception point information 16, and the like as the scene information set in the virtual space. Furthermore, the input condition 10 may include setting information 18 indicating information regarding a reproduction environment of the content or the like.

The sound source information 12 includes various types of information such as waveform data, a type, and a size of a sound emitted from a sound source, a position and a shape of the sound source, and directivity of the sound.

The object information 14 includes space data and materials such as a wall and a ceiling constituting the virtual space, a position and a shape of an object arranged in the virtual space, a material of the object, and the like. These are not necessarily the same as the data used to display the video, and data different from the data for video display may be correspondingly used for the sound representation, or data of a simplified sound representation obtained by reducing surfaces, polygons, and the like from the data for video display may be generated and used. The sound characteristics (sound impedance and the like) are set in advance for the material of the object. For example, the producer 200 selects an object to be arranged and a material of the object on the user interface, and designates an optional position (coordinate) in the virtual space, so that the object can be arranged.

The sound reception point information 16 indicates a position where a sound emitted from a sound source is to be heard. The sound reception point corresponds to, for example, a position of a head of a character in the game in the case of game content.

The setting information 18 is information such as a type of a reproduction machine from which the content is reproduced and a platform on which the content is distributed. By setting these pieces of information, the sound producing device 100 can generate the sound signal in consideration of the characteristics of the reproduction environment. Furthermore, the setting information 18 may include information (hereinafter, referred to as “scene setting”) associated with a scene where the producer 200 intends to generate the sound signal. For example, the scene setting is indicated by a situation of a scene to be set in the current virtual space, such as “daily scene”, “tense scene”, or “battle scene”. Although details will be described later, the sound producing device 100 may perform processing of automatically adjusting the output of each solver in association with each scene setting, for example.

The generator 30 includes a direct sound solver 32, an early reflected sound solver 34, a diffracted sound solver 36, a transmitted sound solver 38 and a late reverberation sound solver 40. Each of the solvers outputs a value corresponding to an input value when a parameter based on the input condition 10 is input.

Note that there are a plurality of types of solvers according to calculation methods and the like, and the sound producing device 100 selects the solvers according to input conditions. For example, the sound producing device 100 can select, as the late reverberation sound solver 40, either a first late reverberation sound solver that performs calculation based on a geometric method or a second late reverberation sound solver that performs calculation based on a wave analysis method. Furthermore, the sound producing device 100 may make a selection not to use a specific solver according to an input condition. For example, in a case where it is understood that there is no sound transmitted between the sound source and the sound reception point in the virtual space, the sound producing device 100 can select not to use the transmitted sound solver 38 in generation of the sound signal.

The parameter controller 50 controls parameters input to the generator 30. First, in a case where the input condition 10 is input from the producer 200, the parameter controller 50 derives the first parameter (parameter before change) to be input to the generator 30 based on such a condition. After the sound signal is generated based on the first parameter, when the first parameter or the sound signal is edited by the producer 200, the parameter controller 50 derives the second parameter (changed parameter) to be input to the generator 30 based on the changed data.

In the embodiment, the parameter controller 50 has a plurality of models for deriving parameters. For example, the parameter controller 50 includes a simulation model 52 and an analytical solution model 54.

The simulation model 52 is, for example, a calculator modeled through learning by deep learning (PINNs: also referred to as Physics Informed Neural Networks) satisfying the physical rule. According to the simulation model 52, the wave component of the sound can be calculated at high speed without solving the wave equation in all spaces.

The analytical solution model 54 is a calculator that analytically calculates a parameter according to a physical rule between the solvers. For example, according to the known technology, when the early reflected sound changes, the influence of the data after the change on the late reverberation sound can be analytically calculated. In a case where some change is made by the producer 200, the analytical solution model 54 derives the second parameter to be applied after the change by analytically calculating what influence the change has.

For example, the parameter controller 50 can generate the second parameter with physical consistency by selectively using the simulation model 52 or the analytical solution model 54 according to the content of change by the producer 200.

As described above, after acquiring the input condition 10, the sound producing device 100 sends the input condition 10 to the parameter controller 50 and selects an appropriate solver. Furthermore, the sound producing device 100 determines parameters to be input to each selected solver based on the input condition 10. The sound producing device 100 generates a sound signal as illustrated in the graph 60 based on the information output from each solver. Thereafter, in a case where the producer 200 changes a parameter or the like to be input to the solver, the sound producing device 100 feeds back to the parameter controller 50 so that an unnatural sound is not generated by the change, thereby automatically adjusting the parameter to be input to another solver. As a result, the sound producing device 100 can generate a sound signal that is consistent with the sound intended by the producer 200.

### 1-2. Configuration of Sound Producing Device According to Embodiment

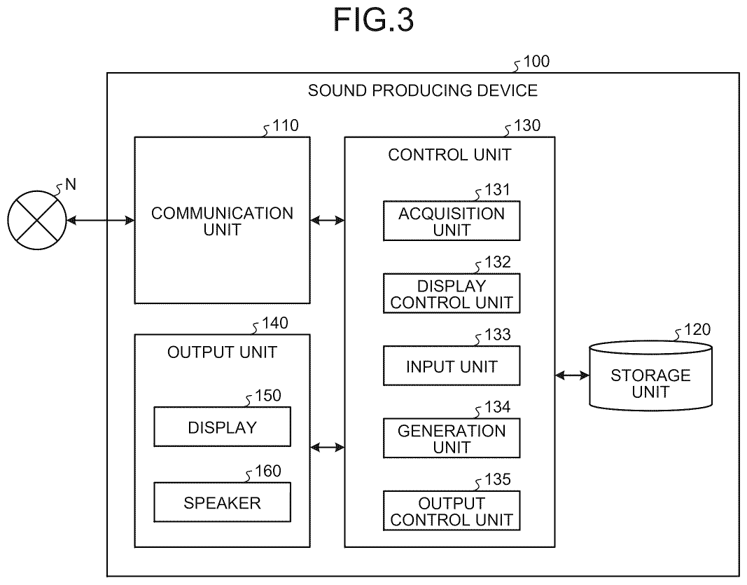

Next, a configuration of the sound producing device 100 according to the embodiment will be described with reference to FIG. 3. FIG. 3 is a diagram illustrating a configuration example of the sound producing device 100 according to the embodiment.

As illustrated in FIG. 3, the sound producing device 100 includes a communication unit 110, a storage unit 120, a control unit 130, and an output unit 140. Note that the sound producing device 100 may include an input unit (for example, a pointing device such as a touch panel, a keyboard, or a mouse, a voice input microphone, or an image input camera (line-of-sight, gesture input)) or the like that performs various operation inputs from the producer 200 or the like that operates the sound producing device 100.

The communication unit 110 is realized by, for example, a NIC (Network Interface Card), a network interface controller, or the like. The communication unit 110 is connected to the network N in a wired or wireless manner, and transmits and receives information to and from an external device or the like via the network N. The network N is realized by, for example, a wireless communication standard or system such as Bluetooth (registered trademark), the Internet, Wi-Fi (registered trademark), Ultra Wide Band (UWB), or Low Power Wide Area (LPWA).

The storage unit 120 is realized by, for example, a semiconductor memory element such as a Random Access Memory (RAM) or a flash memory, or a storage device such as a hard disk or an optical disk. The storage unit 120 stores various types of data such as voice data output from the sound source, shape data of a virtual space or an object, preset setting of a sound absorption coefficient, a type of a solver, and preset setting.

The control unit 130 is realized by, for example, a Central Processing Unit (CPU), a Micro Processing Unit (MPU), or the like executing a program (for example, a sound generation control program according to the present disclosure) stored inside the sound producing device 100 using a Random Access Memory (RAM) or the like as a work area. Furthermore, the control unit 130 is a controller, and may be realized by, for example, an integrated circuit such as an Application Specific Integrated Circuit (ASIC) or a Field Programmable Gate Array (FPGA).

As illustrated in FIG. 3, the control unit 130 includes an acquisition unit 131, a display control unit 132, an input unit 133, a generation unit 134, and an output control unit 135, and realizes or executes a function and an action of information processing described below. For example, the control unit 130 executes processing corresponding to the parameter controller 50 illustrated in FIG. 1 and the like. Note that the internal configuration of the control unit 130 is not limited to the configuration illustrated in FIG. 3, and may be another configuration as long as information processing to be described later is performed.

The acquisition unit 131 acquires various types of data used for processing by a processing unit in a subsequent stage. For example, the acquisition unit 131 acquires preset data including a virtual space or a sound source as a processing target, setting of a solver used for generating a sound, and the like. Furthermore, the acquisition unit 131 may appropriately acquire various types of information required by the processing unit in the subsequent stage, such as a library in which a sound absorption coefficient for each material is stored, and a late reverberation sound preset.

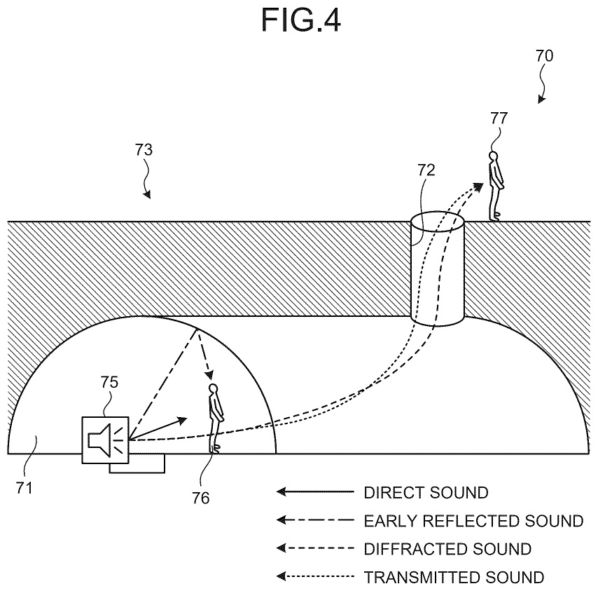

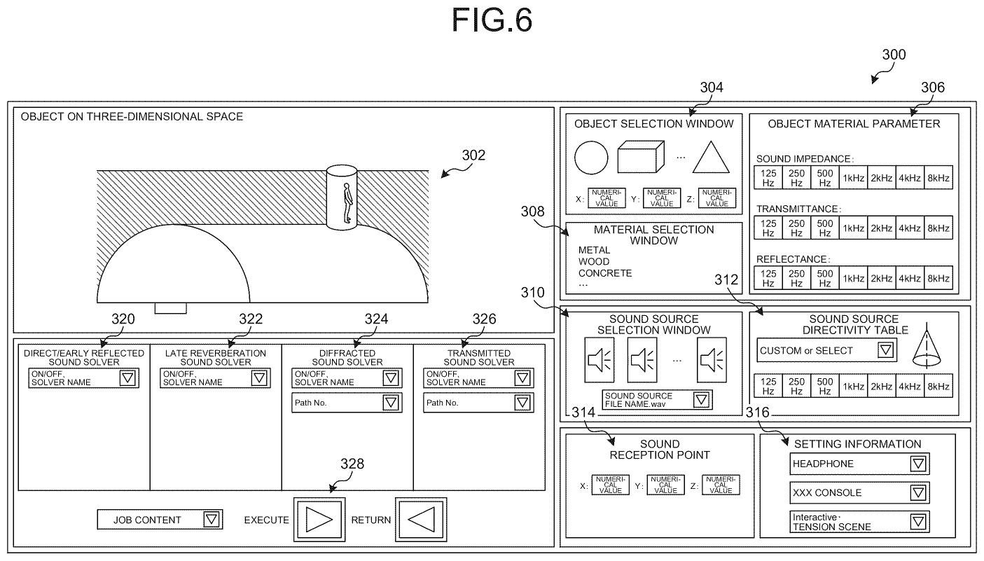

The display control unit 132 performs control to display various types of information regarding the sound simulator provided by the sound producing device 100 on a display or the like. For example, the display control unit 132 displays a virtual space illustrated in FIG. 4 and subsequent drawings, a user interface illustrated in FIG. 6 and subsequent drawings, and the like.

Furthermore, in a case where the parameter or the environment data (the shape of the object or the like) is changed by the processing of the input unit 133 or the generation unit 134 in the subsequent stage, the display control unit 132 performs control to change the display on the user interface based on the change.

The input unit 133 receives an input of environment data indicating each condition set in the virtual space in which the sound source and the sound reception point are arranged. For example, the input unit 133 receives the input of the environment data from the producer 200 via the user interface.

After generating the sound signal, the input unit 133 may receive an input of a change to each solver that has generated the characteristics of the related sound signal. As an example, the input unit 133 receives a change in setting of characteristics related to early reflected sound and late reverberation sound in the sound signal. For example, the input unit 133 inputs settings of the early reflected sound and the late reverberation sound desired by the producer 200 according to the operation of the producer 200 via the user interface.

Specifically, the input unit 133 inputs, on the user interface, parameters indicating the characteristics related to the early reflected sound and the late reverberation sound based on data input by the producer 200 using an input device (touch panel, keyboard, pointing device such as mouse, microphone, camera, and the like).

The generation unit 134 executes each processing related to generation of the sound signal. For example, the generation unit 134 selects a plurality of solvers for calculating sound characteristics at the sound reception point according to the environment data input by the input unit 133. Additionally, the generation unit 134 determines the first parameter to be input to each of the plurality of selected solvers.

As described above, each of the plurality of solvers is associated with the calculation of the characteristics of each of the direct sound, the early reflected sound, the diffracted sound, the transmitted sound, and the late reverberation sound of the sounds at the sound reception point.

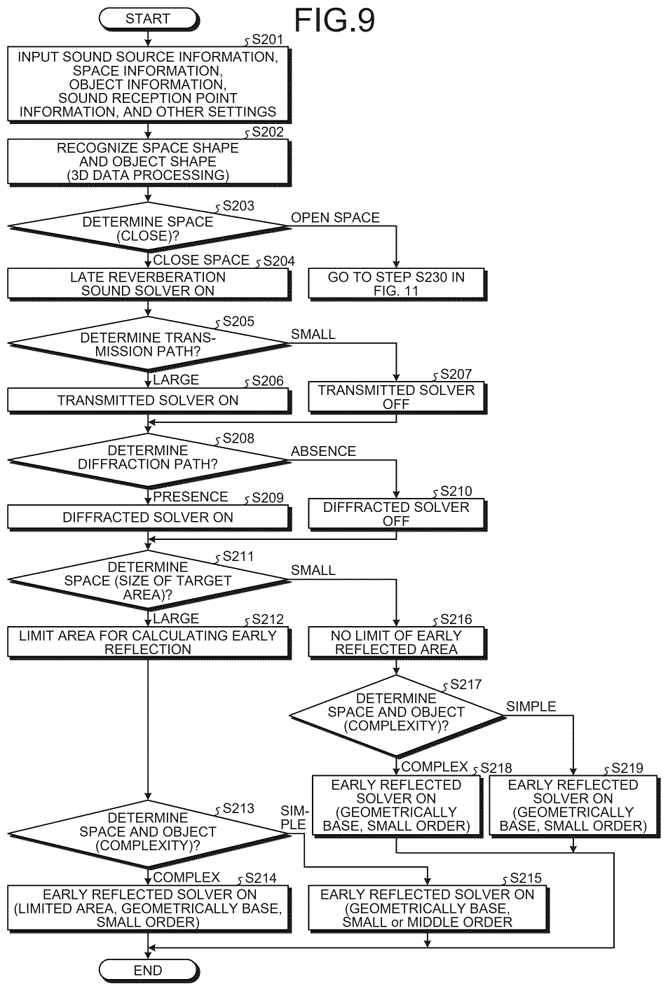

Note that the generation unit 134 selects whether or not to be used as a solver that generates a first sound signal or a second sound signal among the plurality of solvers according to the environment data. For example, the generation unit 134 selects, from the environment data, whether or not the space as a processing target is closed, whether or not there is a geometric obstacle between the sound source and the sound reception point (for example, whether or not the sound reception point can be recognized from the sound source), or whether or not the sound source and the sound reception point are used as a solver that generates a sound signal based on a transmission loss between the sound source and the sound reception point. Details of such processing will be described later with reference to FIG. 9 and the like.

Furthermore, the generation unit 134 receives a change request for the first sound signal generated based on the first parameter. Further, the generation unit 134 automatically adjusts the environment data or the first parameter in response to the change request, and generates the second sound signal using the adjusted environment data or the second parameter that is the adjusted parameter and is newly input to each of the solvers.

For example, in a case where any one of the first parameters input to the solver corresponding to any one of the direct sound, the early reflected sound, the diffracted sound, the transmitted sound, and the late reverberation sound is changed, the generation unit 134 changes the parameter input to the other solver to the second parameter according to the physical rule between the changed solver and the other solver. Here, the physical rule may be based on an analytical solution by a theoretical formula, or may be based on a wave sound simulator that predicts a sound field in a virtual space. The analytical solution according to the theoretical formula is, for example, to analytically obtain the relationship between the solvers based on physical calculation. The solution by the wave sound simulator is obtained using, for example, a calculator (simulator) modeled through learning by deep learning satisfying the physical rule. Details of these processes will be described later with reference to FIG. 4 and subsequent drawings.

The output control unit 135 performs control to output the sound signal generated by the generation unit 134. For example, the output control unit 135 performs control to output the first sound signal generated by the generation unit 134 or the second sound signal corresponding to the sound after the parameter is changed by the producer 200 from a speaker 160, an external device, or the like.

The output unit 140 outputs various types of information. As illustrated in FIG. 3, the output unit 140 includes a display 150 and a speaker 160. Under the control of the display control unit 132, the display 150 displays a virtual space as a processing target or displays a user interface for the producer 200 to input an operation. The speaker 160 outputs the generated sound or the like under the control of the output control unit 135.

### 1-3. Outline of Sound Simulation According to Embodiment

A sound simulation according to the embodiment will be described with reference to FIG. 4 and subsequent drawings. FIG. 4 is a diagram for describing an outline of the sound simulation according to the embodiment.

A virtual space 70 illustrated in FIG. 4 is an example of environment data set by the producer 200 for the sound simulation in the game content. The virtual space 70 includes a tunnel-like space 71 having a relatively large volume and a tunnel-like space 72 having a relatively small volume. The space 71 and the space 72 are set assuming an underground space, for example. Furthermore, the virtual space 70 includes a ground space 73 set as a free sound field from the space 71 via the space 72.

In a case where a sound simulation regarding the sound of water emitted from a sewage path existing in the space 71 is performed in the virtual space 70, the producer 200 sets the sound source 75 at a position indicating the sewage path in the space 71. Furthermore, the producer 200 regards the game character as a sound reception point and sets a sound reception point 76 in the underground space, a sound reception point 77 in the ground space 73, and the like. This is a situation in which the game character moves from the underground space to the ground space 73.

When receiving the input of the environment data, the sound producing device 100 determines the sound reaching the sound reception point 76 and the sound reception point 77 using a method such as ray tracing based on geometric acoustics. Furthermore, the sound producing device 100 determines whether or not the transmitted sound reaches the sound reception point 76 or the sound reception point 77 based on the material or the like of the object set in the virtual space 70.

As illustrated in FIG. 4, at the sound reception point 76, a sound is mainly configured by a direct sound or an early reflected sound from the sound source 75. Furthermore, at the sound reception point 77, sound is mainly configured by transmitted sound transmitted through the space 72, diffracted sound diffracted from the space 71 or the space 72, a combination thereof, or the like. In this manner, the sound producing device 100 determines the elements constituting the sound at the sound reception point based on the environment data, and selects a solver for generating each element. Furthermore, the sound producing device 100 determines parameters to be input to the solver.

Note that the sound producing device 100 may select a solver designated by the producer 200. As described above, in the virtual space 70, not only the sound configuration according to the physical rule but also an unrealistic sound configuration intended by the producer 200 as a production may be preferred. Therefore, when there is a request for changing the solver or the like from the producer 200, the sound producing device 100 changes the solver according to the request.

When the solver or an early parameter (first parameter) to be input to the solver is determined based on the environment data, the sound producing device 100 generates a sound signal observed at the sound reception point 76 or the sound reception point 77.

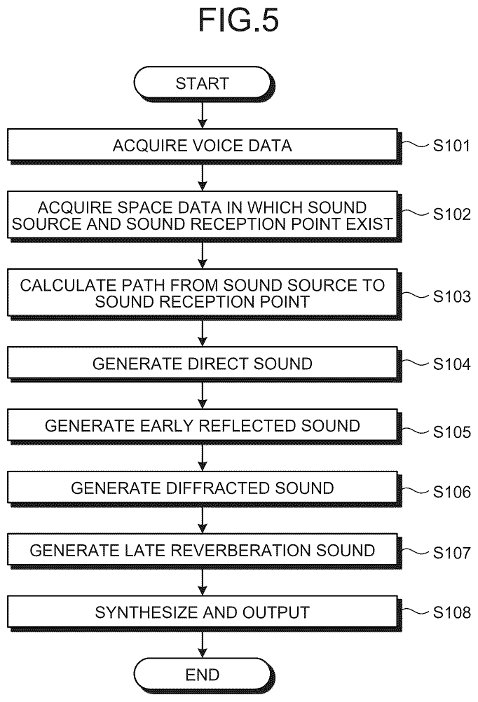

The generation processing of the above sound signal will be described with reference to FIG. 5. FIG. 5 is a flowchart illustrating a flow of voice generation processing in the sound simulation.

First, the sound producing device 100 acquires voice data of a sound emitted from the sound source 75 (Step S101). Furthermore, the sound producing device 100 acquires space data of a space in which the sound source 75, the sound reception point 76, and the sound reception point 77 exist (Step S102).

Subsequently, the sound producing device 100 calculates a path from the sound source 75 to the sound reception point 76 or the sound reception point 77 (Step S103). Then, the sound producing device 100 generates a direct sound component using the direct sound solver (Step S104).

Similarly, the sound producing device 100 generates an early reflected sound component using the early reflected sound solver (Step S105). Similarly, the sound producing device 100 generates a diffracted sound component using the diffracted sound solver (Step S106). At this time, in a case where it is determined in Step S103 that the sound is transmitted to the sound reception point, the sound producing device 100 may generate the transmitted sound component using the transmitted sound solver. Furthermore, the sound producing device 100 generates a late reverberation sound component using the late reverberation sound solver (Step S107).

Finally, the sound producing device 100 synthesizes the respective voice signals and outputs the synthesized voice signal (Step S108).

Note that, in a case where the sound signal is first generated based on the environment data, the generation processing according to Steps S104 to S107 does not depend on the order between the respective steps, and thus, may be interchanged. In addition, when considering a case where diffraction occurs after reflection in a propagation path, a signal generated by calculating reflection attenuation at a boundary from a sound source in advance may be used as an input in calculation of a diffracted sound.

Furthermore, although not taken into consideration in the example of FIG. 4, the sound producing device 100 may add processing using a transmission simulation of a sound on a boundary surface or a portability simulation technique that simulates a characteristic when a small sound passes through a space such as a window or a door of a building. As a result, the sound producing device 100 can realize sound expression closer to the phenomenon of the real space.

Furthermore, in a case where there is a plurality of sound sources, the sound producing device 100 may process the entire processing described above in parallel for the sounds output from the plurality of sound sources. Alternatively, the sound producing device 100 may delay the time until the output until the entire processing is completed and sequentially perform the processing, and further synthesize and output each synthesis signal in which the time series of the arrival sound at the sound reception point is aligned.

Next, a user interface used when the producer 200 executes the above sound simulation will be described with reference to FIG. 6 and subsequent drawings. FIG. 6 is a diagram (1) for explaining a user interface of the sound simulation according to the embodiment.

As illustrated in FIG. 6, a user interface 300 includes a virtual space display 302, an object selection window 304, an object material parameter display 306, a material selection window 308, a sound source selection window 310, a sound source directivity table 312, a sound reception point setting display 314, and setting information 316.

The virtual space display 302 displays a virtual space constructed based on the environment data input by the producer 200. In the example of FIG. 6, the virtual space 70 illustrated in FIG. 4 is displayed in the virtual space display 302.

The object selection window 304 is a window for the producer 200 to select an object to be added to the virtual space. When the producer 200 adds an object to the virtual space, the sound producing device 100 displays the object on the virtual space based on the shape data preset for the object. Furthermore, the producer 200 can select the material of the object using the material selection window 308. For each material, sound characteristics as shown in the object material parameter display 306 are preset for each frequency. When the producer 200 installs an object in the virtual space, the sound producing device 100 acquires such a shape and sound characteristics as environment data, and calculates a sound on the virtual space based on the acquired data.

Furthermore, the producer 200 selects a sound source that emits a sound in the virtual space from the sound source selection window 310. For example, each icon shown in the sound source selection window 310 is associated with a sound source file to be each voice data. The producer 200 selects the icon (or the voice file itself) corresponding to the sound to be emitted, thereby determining the sound source on the virtual space. At this time, the producer 200 can select the directivity of the sound emitted from the sound source from the presets using the sound source directivity table 312, or can customize and set the directivity by itself.

In addition, the producer 200 sets a sound reception point that is coordinates for observing sound in the virtual space on the sound reception point setting display 314. In addition, the producer 200 selects an environment in which the content indicated by the virtual space is reproduced in the setting information 316. For example, the producer 200 selects whether the environment in which the content is reproduced is a speaker or a headphone, or selects the type of reproduction console of the content. Furthermore, the producer 200 can select a scene setting in a situation to be simulated. For example, the producer 200 selects whether such a scene is a “tense scene” or another scene from preset scene settings.

In addition, the user interface 300 includes a direct/early reflected sound solver setting 320, a late reverberation sound solver setting 322, a diffracted sound solver setting 324, and a transmitted sound solver setting 326.

The sound producing device 100 determines whether or not to use each of the solvers, which type of solver to use, a value of a parameter to be input to the solver, or the like based on the input environment data. Note that the producer 200 can also determine to use the solver desired by himself/herself.

Also, the user interface 300 includes an execution button 328 as an operation panel. The producer 200 requests execution of each processing described later and redoing through the operation panel.

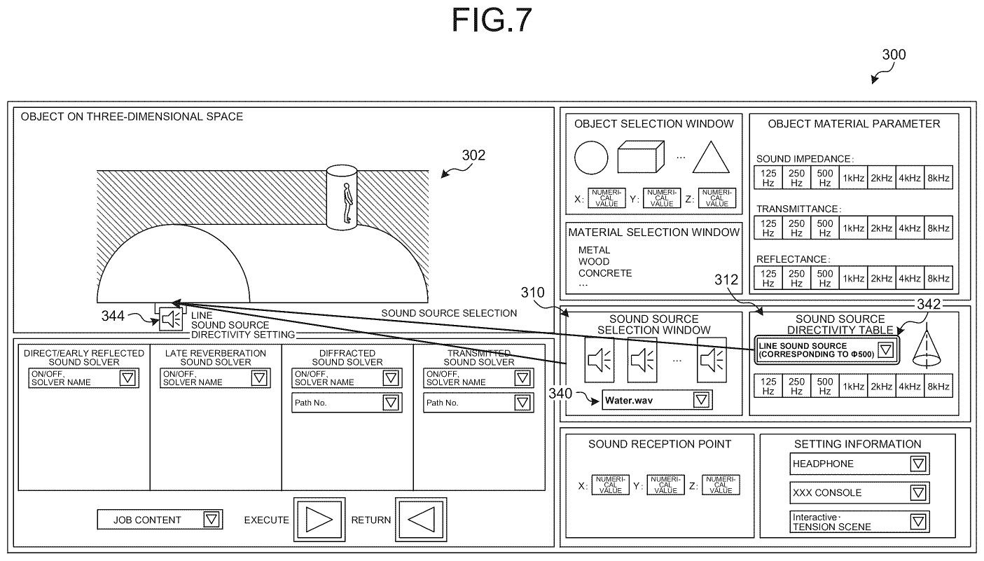

Next, the use of the user interface 300 will be described with reference to FIG. 7. FIG. 7 illustrates an example in which the producer 200 inputs environment data (early setting) into the sound simulation. FIG. 7 is a diagram (2) for explaining a user interface of the sound simulation according to the embodiment.

When the producer 200 uses the sound of water emitted from the sewage path existing in the virtual space as the sound source, the producer 200 selects an icon corresponding to water from the sound source selection window 310 and drags the icon to desired coordinates of the virtual space display 302. The sound producing device 100 displays a voice file 340 (in the example of FIG. 7, “water. wav”) set to the icon based on the selected icon. Furthermore, the sound producing device 100 displays a sound source display 344 at the position where the sound source is dragged.

Furthermore, the producer 200 operates the sound source directivity table 312 to determine the directivity of the sound source and the like. In the example of FIG. 7, since the sound of water emitted from the sewage path is assumed, the producer 200 selects the line sound source. The sound producing device 100 displays a directivity display 342 (in the example of FIG. 7, “line sound source (corresponding to φ 500)”) based on the selected directivity.

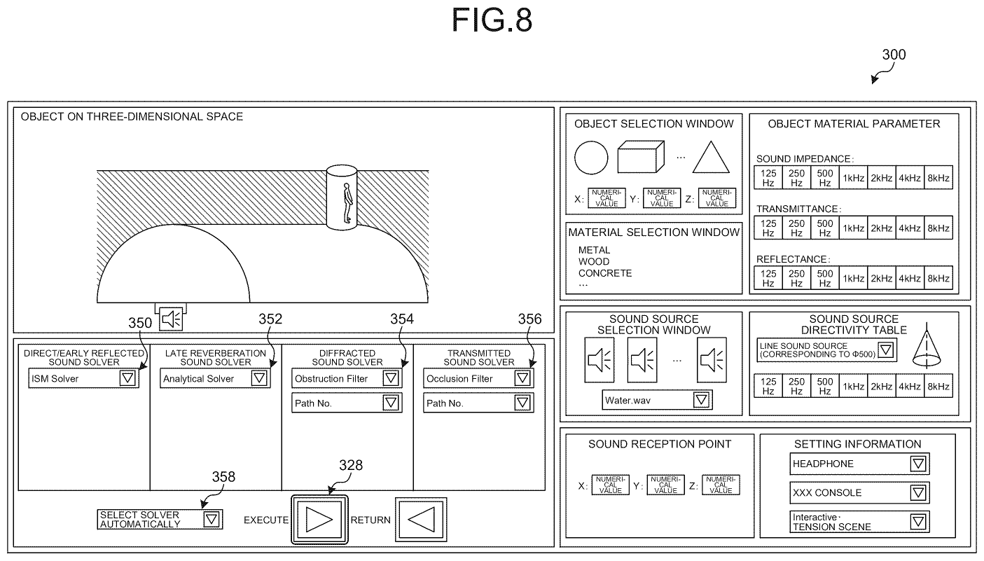

Continuing from FIG. 7, an operation example of the sound simulation will be described with reference to FIG. 8. FIG. 8 is a diagram (3) for explaining a user interface of the sound simulation according to the embodiment.

FIG. 8 illustrates a state in which the sound producing device 100 selects each solver in response to the input of the environment data. It is assumed that the producer 200 operates a solver selection display 358 in advance to determine whether to select the solver by itself or automatically.

In a case where the solver is automatically selected, the sound producing device 100 presents the selected solver to the producer 200. In the example of FIG. 8, the sound producing device 100 displays the solver selected as the direct/early reflected sound solver on a display 350 (“ISM Solver” in the example of FIG. 8). Similarly, the sound producing device 100 displays the solver selected as the late reverberation sound solver on a display 352, displays the solver selected as the diffracted sound solver on a display 354, and displays the solver selected as the transmitted sound solver on a display 356.

When the producer 200 presses the execution button 328 in this state, the sound producing device 100 generates a sound signal using the selected solver.

Here, a flow of selection processing of the solver will be described. FIG. 9 is a flowchart (1) illustrating the flow of solver select processing in the sound simulation.

The sound producing device 100 inputs environment data including sound source information, space information, object information, sound reception point information, other settings, and the like in accordance with the instruction of the producer 200 (Step S201). Note that the environment data may include the position and directivity of the sound source, the geometric shape and material of the entire virtual space, the user environment such as the platform on which the content is used and the reproduction environment resource, the scene setting, and the like.

Then, the sound producing device 100 recognizes the space shape and the object shape and performs 3D data processing (Step S202). The sound producing device 100 determines whether the space as a processing target is closed or opened based on the 3D data (Step S203).

Note that the sound producing device 100 can optionally determine the space as a processing target. For example, the sound producing device 100 sets a space scene to be a processing target as an area covering a specific scale multiple (for example, 1.5 times) of a range in which a sound source and a sound reception point (a game character or the like) can move. Alternatively, the sound producing device 100 may use ray tracing for image generation to set, as a processing target, an area where a sound reaches within a specific time (for example, 1 second) by emitting a light beam from a sound reception point.

Furthermore, whether or not the space is closed can also be determined by the sound producing device 100 based on an optional criterion. For example, the sound producing device 100 may determine a space in which the ratio of the wall surface or the ceiling in the calculation target space exceeds a specific value (for example, 70%) as the closed space. As an example, in the virtual space 70 illustrated in FIG. 4, the space 71 and the space 72 are determined as closed spaces, and the ground space 73 is determined as a non-closed space.

If the space is closed, the sound producing device 100 determines that late reverberation sound is present and determines to utilize the late reverberation sound solver (Step S204).

Note that, as the late reverberation sound solver, for example, a solver by analytical solution (Analytical Solver) and a solver by geometric method (Numerical Solver) such as ray tracing or sound ray method can be used. The sound producing device 100 may automatically determine which late reverberation sound solver to use based on the execution environment (calculation resource or the like) of the content.

Furthermore, the reverberation time that is important in the late reverberation sound solver is obtained from the following Formula (1), which is known as a reverberation formula of Sabine in the field of building sounds, based on the sound absorption coefficient, volume, and surface area of the object.

$$T = 0.161 V / \overline{α} S \qquad ( 1 )$$

In the above Formula (1), V represents a target spatial volume, S represents a total surface area, and a represents an average sound absorption coefficient. Note that the reverberation time is not limited to the Savin equation, and may be obtained by another known formula (Eyring's formula, Knudsen's formula, or the like).

Furthermore, the echo density (Diffusion), which is another factor of the late reverberation sound, can be analytically obtained from the following Formula (2) based on the volume of the target space.

$$\frac{dN ( t )}{dt} = 4 π \frac{{c}^{3}}{V} {t}^{2} \qquad ( 2 )$$

Similarly, the modal density (Density), which is another factor of the late reverberation sound, can be analytically obtained from the following Formula (3) based on the volume of the target space.

$$\frac{dN ( f )}{dt} = 4 π \frac{{c}^{3}}{V} {f}^{2} \qquad ( 3 )$$

Subsequently, the sound producing device 100 determines a transmission path from the sound source to the sound reception point (Step S205).

For example, when it is determined that the transmission amount of the sound is larger than the predetermined reference value because a material having a high transmittance is used for the space or the object between the sound source and the sound reception point, or the like, the sound producing device 100 determines that there is a transmitted sound and determines to use the transmitted sound solver (Step S206).

On the other hand, when it is determined that the transmission amount of the sound is smaller than the predetermined reference value because a material having a low transmittance is used for the space or the object between the sound source and the sound reception point, or the like, the sound producing device 100 determines that there is no transmitted sound (or the transmitted sound can be ignored) and determines not to use the transmitted sound solver (Step S207).

For example, in order to determine the presence or absence of the transmitted sound, the following Formula (4) is used. Note that, in the following Formula (4), m represents the area density of obstacles between the sound source and the sound reception point.

$$TL = 20 log ( fm ) - 42 [ dB ] \qquad ( 4 )$$

For example, in the virtual space 70 illustrated in FIG. 4, when the game character is located in the space 72, the game character (sound reception point) cannot be seen from the sound source 75. In addition, it is assumed that the material set in the spaces 71 and 72 is concrete and a transmission loss TL is 40 dB or more. In this case, the sound producing device 100 determines that no transmitted sound is generated. Note that the sound producing device 100 can calculate the sound from the sound source 75 to the space 72 on the assumption that the sound has propagated as a diffracted sound to be described later. On the other hand, since the transmission loss TL is assumed to be 40 dB or less between the space 72 and the ground space 73, a transmitted sound is generated.

Subsequently, the sound producing device 100 determines a diffraction path from the sound source to the sound reception point (Step S208).

For example, in a case where the space between the sound source and the sound reception point or the shape of the object generates the diffracted sound, the sound producing device 100 determines that the diffracted sound exists and determines to use the diffracted sound solver (Step S209).

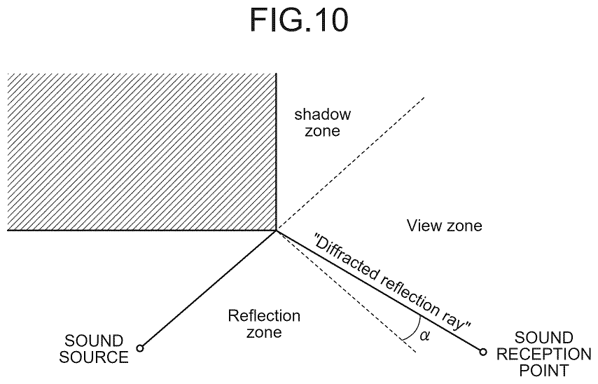

The diffracted sound solver will be described with reference to FIG. 10. FIG. 10 is a diagram for explaining application of the diffracted sound solver. As illustrated in FIG. 10, the sound producing device 100 can obtain a table in which the frequency characteristic curve for each angle a when the sound generated from the sound source diffracts the obstacle by using the diffracted sound solver. The sound producing device 100 can generate a sound signal in consideration of the influence of the diffracted sound by combining signals relating to the generated sound signal. Note that the presence or absence of the diffracted sound may be automatically determined by the sound producing device 100 by a geometric method as illustrated in FIG. 10, or may be determined by the intention of the producer 200 in a case where the producer 200 considers the diffracted sound to be important.

Returning to FIG. 9, the description will be continued. In Step S208, when the space between the sound source and the sound reception point or the shape of the object does not generate the diffracted sound (or can be ignored), the sound producing device 100 determines that the diffracted sound does not exist and determines not to use the diffracted sound solver (Step S210).

Thereafter, the sound producing device 100 determines the size of the space (that is, the processing target area of the sound simulation) (Step S211).

In a case where the space is larger than the predetermined reference value, the sound producing device 100 limits the area for calculating the early reflected sound (Step S212). Furthermore, the sound producing device 100 determines the complexity of the shape of the space and the shape of the object (Step S213). In a case where the complexity is higher than the predetermined reference value, the sound producing device 100 determines the parameter to reduce the order to be calculated by using the early reflected sound solver that is applied to the limited area and is geometrically based (Step S214). On the other hand, if the complexity is lower than the predetermined reference value (in a simple case), the sound producing device 100 determines the early reflected sound solver to be geometry-based and to have a low or medium order of parameters (Step S215).

The reason why the space size is determined as described above is that when the space size increases, the time it takes for the sound to reach the sound reception point is separated from the direct sound, which does not contribute to the sound size on the sense of positioning or loudness expected in the early reflected sound. Therefore, the sound producing device 100 determines the space size as “large” or “small” based on a case where the early reflected sound is separated from the direct sound by a predetermined time or more (for example, 80 ms), and changes the calculation method according to the space size. For example, in a case where the sound producing device 100 determines that the space size is “large”, the space for performing calculation related to the early reflected sound is limited to an area where the early reflected sound falls within 80 ms. Thereafter, the complexity of the space and the object is calculated in Step S213, but the calculation load increases in a case where the shape is complicated, and thus the sound producing device 100 determines the reflection order as a parameter to be small. Note that, in a case where the complexity of the space is low, the sound producing device 100 sets the order up to the early reflected sound area (for example, within 80 ms) in (2) above. The sound producing device 100 basically generates a parameter according to the above determination also in each branch (Steps S213, S217, S237, S241, and the like) to be described later.

In a case where it is determined in Step S211 that the space is smaller than the predetermined reference value, the sound producing device 100 does not limit the area for calculating the early reflected sound (Step S216). Similarly to Step S213, the sound producing device 100 determines the complexity of the shape of the space and the shape of the object (Step S217). If the complexity is higher than the predetermined reference value, the sound producing device 100 determines an early reflected sound solver that is geometrically based and has a smaller order of parameters (Step S218). Furthermore, in a case where the complexity is lower than the predetermined reference value (in a simple case), the sound producing device 100 determines the early reflected sound solver that is geometrically based and has a small order (Step S219).

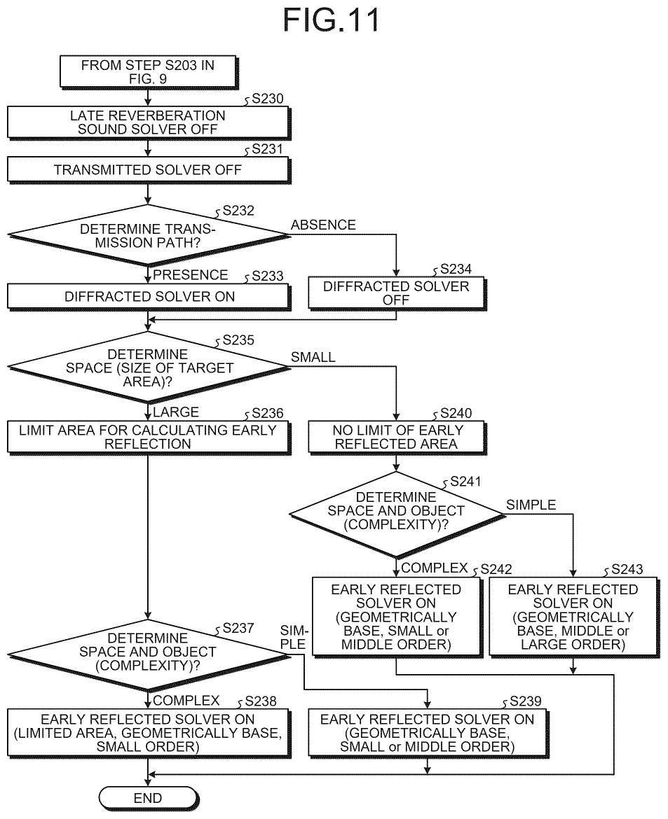

Furthermore, a flow in a case where the processing target is an open space in Step S203 will be described with reference to FIG. 11. FIG. 11 is a flowchart (2) illustrating the flow of solver select processing in the sound simulation.

In a case where the processing target is an open space, the sound producing device 100 determines not to use the late reverberation sound solver and the transmitted sound solver (Steps S230 and S231).

Furthermore, the sound producing device 100 determines a diffraction path from the sound source to the sound reception point similarly to Step S208 (Step S232).

For example, in a case where the space between the sound source and the sound reception point or the shape of the object generates the diffracted sound, the sound producing device 100 determines that the diffracted sound exists and determines to use the diffracted sound solver (Step S233).

On the other hand, when the space between the sound source and the sound reception point or the shape of the object does not generate the diffracted sound (or can be ignored), the sound producing device 100 determines that the diffracted sound does not exist and determines not to use the diffracted sound solver (Step S234).

Thereafter, the sound producing device 100 determines the size of the space similarly to Step S211 (Step S235).

In a case where the space is larger than the predetermined reference value, the sound producing device 100 limits the area for calculating the early reflected sound (Step S236). Furthermore, the sound producing device 100 determines the complexity of the shape of the space and the shape of the object (Step S237). In a case where the complexity is higher than the predetermined reference value, the sound producing device 100 determines the early reflected sound solver to be applied to the limited area, geometrically based and to reduce the order to be calculated (Step S238). On the other hand, if the complexity is lower than the predetermined reference value (in a simple case), the sound producing device 100 determines the early reflected sound solver to be geometry-based and to have a low or medium order (Step S239).

Furthermore, in a case where it is determined in Step S235 that the space is smaller than the predetermined reference value, the sound producing device 100 does not limit the area for calculating the early reflected sound (Step S240). Similarly to Step S237, the sound producing device 100 determines the complexity of the shape of the space and the shape of the object (Step S241). In a case where the complexity is higher than the predetermined reference value, the sound producing device 100 determines the early reflected sound solver to be geometrically based and to have a low or middle order to calculate (Step S242). Furthermore, in a case where the complexity is lower than the predetermined reference value (in a simple case), the sound producing device 100 determines the early reflected sound solver to be geometrically based and to have a middle or high order to be calculated (Step S243).

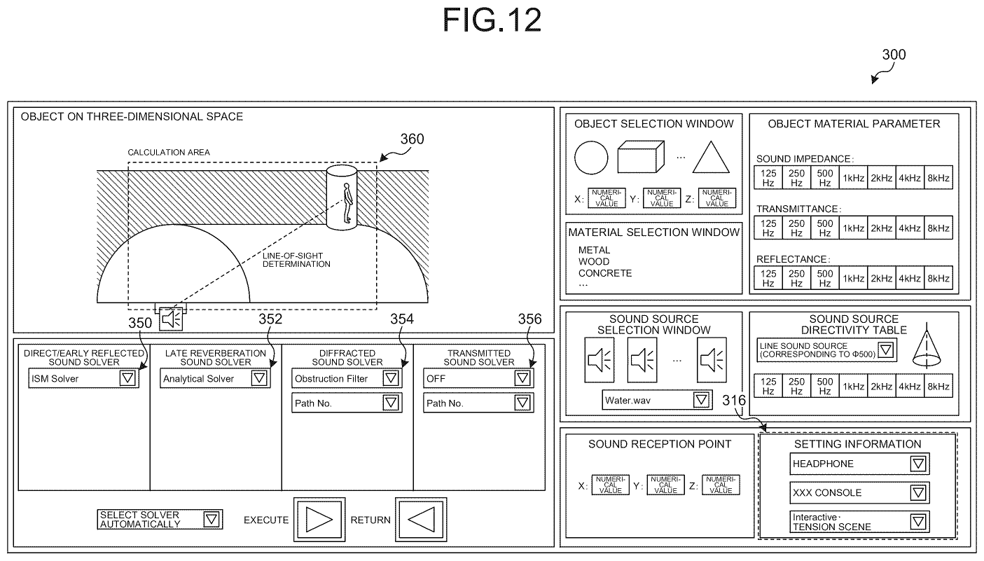

Next, a display example of the user interface 300 when the solver or the parameter is determined will be described with reference to FIG. 12. FIG. 12 is a diagram (4) for explaining the user interface of the sound simulation according to the embodiment.

A display 360 in FIG. 12 illustrates a display example in a case where the producer 200 sets the sound source and the sound reception point. As illustrated in the display 360, the sound producing device 100 performs line-of-sight determination from the sound source to the sound reception point, and determines the solver to be applied in the scene and the parameters of the solver according to the processing illustrated in FIGS. 9 and 11.

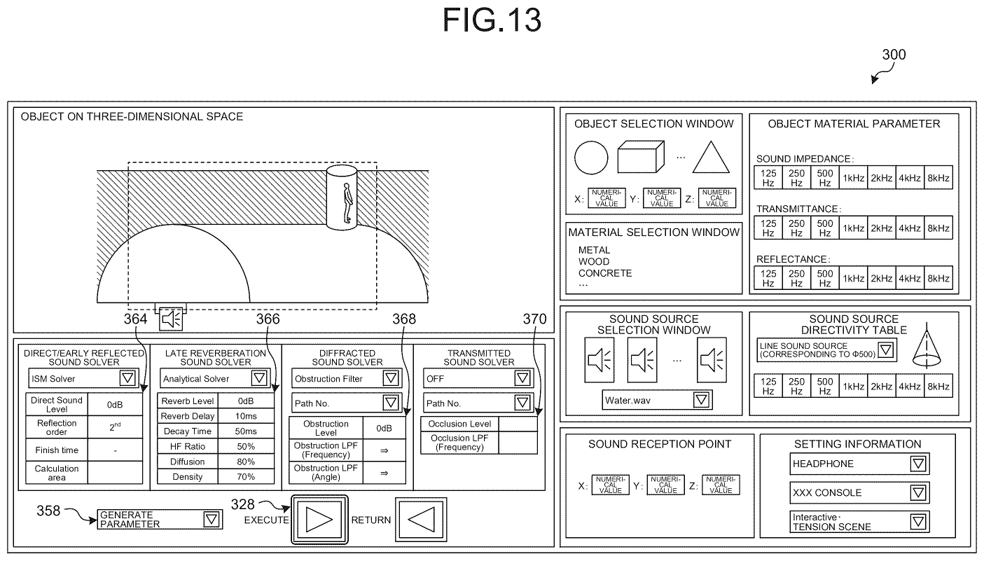

Next, a display example of the user interface 300 when the solver or the parameter is determined will be described with reference to FIG. 13. FIG. 13 is a diagram (5) for explaining the user interface of the sound simulation according to the embodiment.

After the display of FIG. 12, the sound producing device 100 displays the determined solvers and parameters on the user interface 300. In the example of FIG. 13, it is assumed that the producer 200 operates pull-down of the solver selection display 358 in advance to set a parameter generation mode of the solver in the sound simulation. When the producer 200 presses the execution button 328 after setting the parameter generation mode, the sound producing device 100 generates (calculates) the parameters of each solver.

For example, the sound producing device 100 displays a direct/early reflected sound parameter 364, a late reflected sound parameter 366, a diffracted sound parameter 368, and a transmitted sound parameter 370 illustrated in FIG. 13. Note that the sound producing device 100 may synthesize the sound signals based on the generated parameters and output the synthesized sound.

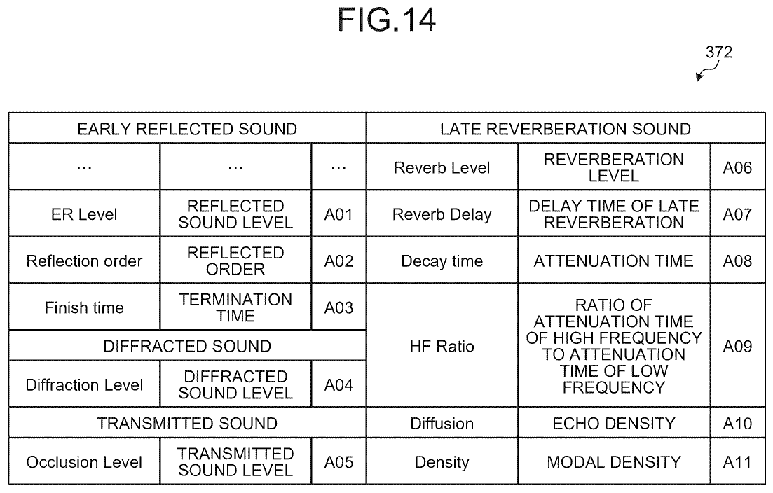

Here, setting items and parameters of the solver will be exemplified with reference to FIG. 14. FIG. 14 is a diagram for explaining parameters of each solver.

As illustrated in FIG. 14, the setting items of the early reflected sound solver may include a reflected sound level, a reflection order, a termination time, and the like. In this case, numerical values input to the reflected sound level, the reflection order, the termination time, and the like are parameters. A display such as “A01” illustrated in FIG. 14 conceptually indicates the parameter.

In addition, as a setting item of the diffracted sound solver, there may be a diffracted sound level. In addition, as a setting item of the transmitted sound solver, there may be a transmitted sound level. Furthermore, the setting items of the late reverberation sound solver may include a reverberation level, a delay time of the late reverberation, an attenuation time, a ratio of an attenuation time of a high frequency to an attenuation time of a low frequency, a modal density, an echo density, and the like.

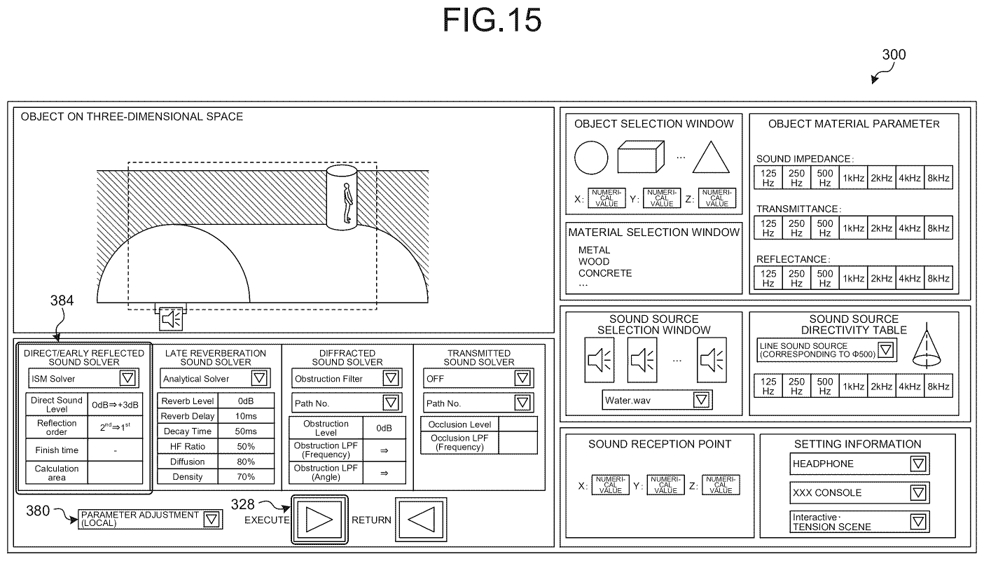

Next, processing in a case where the producer 200 requests a change in the generated parameter or the like will be described with reference to FIG. 15 and subsequent drawings. FIG. 15 is a diagram (6) for explaining the user interface of the sound simulation according to the embodiment.

The parameters illustrated in FIG. 13 are parameters generated by the function of the parameter controller 50, and are calculated based on an analytical solution or a numerical simulation solution based on an input condition, and thus follow the physical rule. That is, the parameter at the present time is a state in which the correlation of the parameters between the solvers is obtained. Therefore, when the producer 200 manually adjusts only some parameters, this physical correlation collapses. Such a relationship that does not follow the physical rule has no problem as long as the relationship is intended as presentation of expression. However, if the relationship is not intended as such and the amount of change exceeds a human discrimination limit, there is a possibility that the relationship adversely affects the user's auditory spatial cognition. However, manually adjusting all of the other relevant parameters for the producer 200 requires complex computations, which is a very demanding task. Therefore, the sound producing device 100 automatically corrects the parameter used in the other solver so that the parameter can be correlated with the changed parameter by the function of the parameter controller 50 conforming to the physical rule.

In the example of FIG. 15, the producer 200 selects “parameter adjustment (local)” from the pull-down of a display 380 in the case of requesting the change of the parameter. Furthermore, the producer 200 selects a parameter requested to be changed, and inputs a desired numerical value. In the example of FIG. 15, as shown in a parameter change display 384, the producer 200 changes the “reflection sound level” and the “reflection order” among the parameters of the direct/early reflected sound solver. That is, the example of FIG. 15 illustrates a case where the producer 200 has changed the parameter A01 and the parameter A02 illustrated in FIG. 14. Here, the “local” parameter adjustment is to adjust a parameter related to one of the solvers controlled by the parameter controller 50.

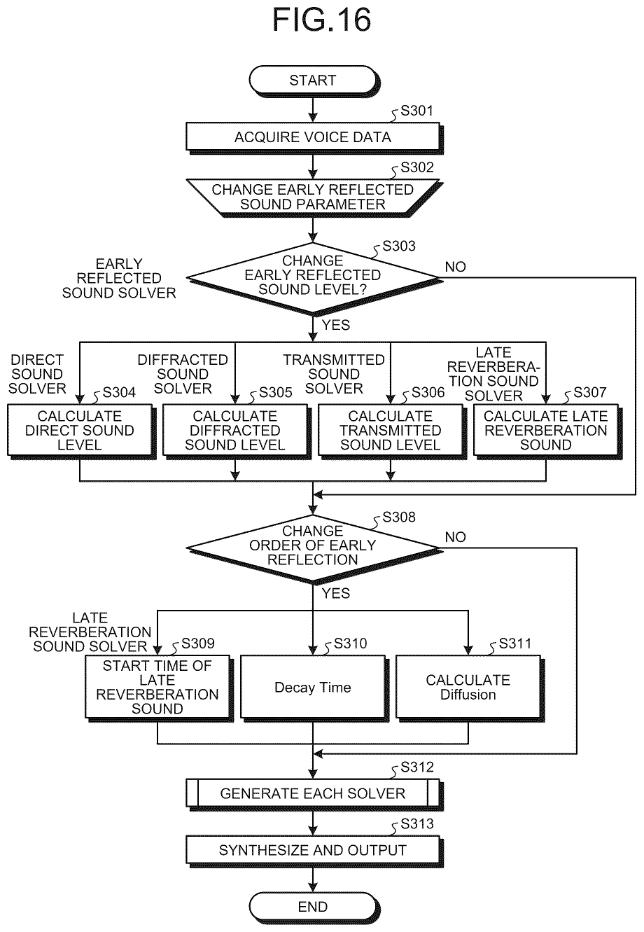

The flow of processing in a case where such a change is made will be described with reference to FIG. 16. FIG. 16 is a flowchart (1) illustrating an example of the flow of the change processing according to the embodiment.

First, the sound producing device 100 acquires voice data generated by the parameter before change (Step S301). Thereafter, some parameter changes regarding the early reflected sound is performed by the producer 200 (Step S302).

The sound producing device 100 determines whether or not the early reflected sound level has been changed in the early reflected sound solver (Step S303). When the early reflected sound level is not changed (Step S303; No), the immediately subsequent processing is skipped.

When the early reflected sound level has been changed (Step S303; Yes), the sound producing device 100 performs level calculation so as to change the level also in the other solvers (Step S304, Step S305, Step S306, and Step S307). For example, the sound producing device 100 reflects, in each of the solvers, an increase or decrease in level that is the same as the early reflected sound level in the parameters of each of the solvers.

Thereafter, the sound producing device 100 determines whether or not an early reflection order has been changed in the early reflected sound solver (Step S308). When the early reflection order is not changed (Step S308; No), the immediately subsequent processing is skipped.

When the early reflection order is changed (Step S308; Yes), the sound producing device 100 changes the parameters of each solver according to the physical rule based on the change value of the order. As an example, since the start time of the late reverberation sound is changed when the early reflection order is changed, the sound producing device 100 changes the start time parameter (corresponding to the parameter A07 shown in FIG. 14) of the late reverberation sound in the late reverberation sound solver (Step S309).

Similarly, the sound producing device 100 corrects the attenuation time in the late reverberation sound solver (corresponding to the parameter A08 illustrated in FIG. 14) to fit the attenuation curve of the early reflected sound after the change (Step S310). In addition, the sound producing device 100 also corrects the echo density of the late reverberation sound (corresponding to the parameter A10 illustrated in FIG. 14) in a manner adapted to the echo density of the early reflection that has been terminated (reduced in order) (Step S311).

Then, the sound producing device 100 generates a signal in each of the solvers whose parameters have been changed (Step S312). Subsequently, the sound producing device 100 outputs a sound signal generated by combining the signals generated by the respective solvers (Step S313).

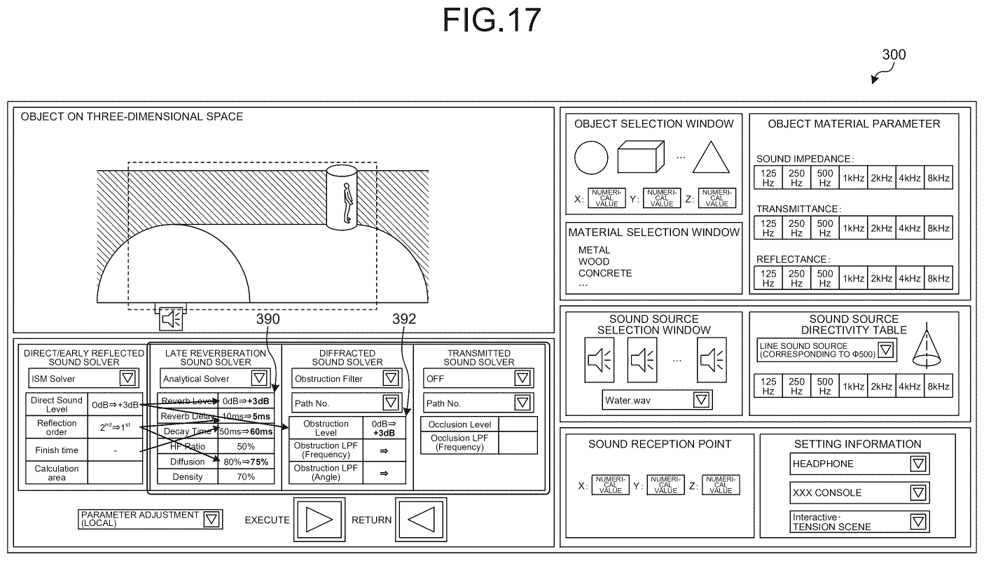

FIG. 17 illustrates a display example of the user interface 300 in a case where the parameter is changed by the processing illustrated in FIG. 16. FIG. 17 is a diagram (7) for explaining the user interface of the sound simulation according to the embodiment.

As illustrated in FIG. 17, in a case where the producer 200 increases the early reflected sound level by 3 dB and changes the early reflection order from the second order to the first order in the parameters of the early reflected sound solver, the parameters of the late reverberation sound solver and the diffracted sound solver are changed.

For example, a late reverberation sound parameter 390 after the change indicates that the late reverberation sound level is increased by 3 dB, the delay time of the late reverberation sound is shortened by 5 ms, and the like. In addition, a changed diffracted sound parameter 392 indicates that the diffracted sound level increases by 3 dB, the setting of the low-pass filter (LPF) of the diffracted sound may change, and the like.

Note that the producer 200 views the sound after the parameter change, and in a case where the producer does not like the sound after the parameter change, the producer can return the processing by pressing a return button on the operation panel. Note that the sound producing device 100 may switchably output the first sound signal based on the first parameter and the second sound signal based on the second parameter according to the operation of the operator on the user interface 300. As a result, the producer 200 can advance the sound design while easily switching the sound before and after the change.

Furthermore, FIGS. 16 and 17 illustrate an example in which the producer 200 changes the parameters of the early reflection, but the producer 200 can change desired parameters such as late reverberation sound and diffracted sound.

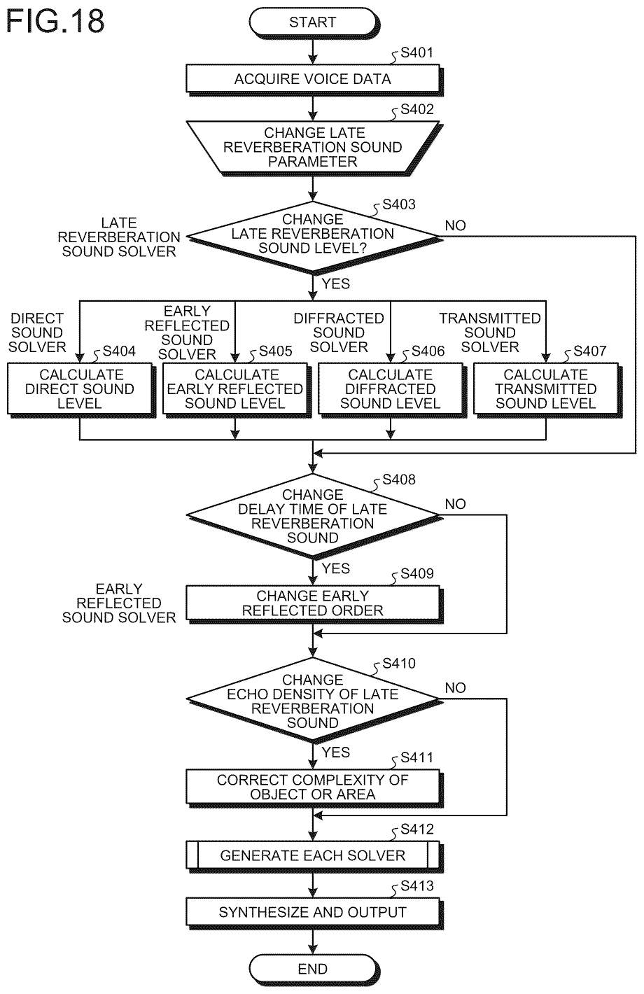

FIG. 18 illustrates a flow of processing in a case where the producer 200 changes the parameter of the late reverberation sound. FIG. 18 is a flowchart (2) illustrating an example of the flow of the change processing according to the embodiment.

First, the sound producing device 100 acquires voice data generated by the parameter before change (Step S401). Thereafter, some parameter changes regarding the late reverberation sound are performed by the producer 200 (Step S402).

The sound producing device 100 determines whether or not the late reverberation sound level has been changed in the late reverberation sound solver (Step S403). When the late reverberation sound level is not changed (Step S403; No), the immediately subsequent processing is skipped.

When the late reverberation sound level has been changed (Step S403; Yes), the sound producing device 100 performs level calculation so as to change the level also in the other solvers (Step S404, Step S405, Step S406, and Step S407). For example, the sound producing device 100 reflects, in each of the solvers, an increase or decrease in level that is the same as the late reverberation sound level in the parameters of each of the solvers.

Thereafter, the sound producing device 100 determines whether or not the delay time of late reverberation (corresponding to the parameter A07 illustrated in FIG. 14) has been changed in the late reverberation sound solver (Step S408). Additionally, when the delay time of the late reverberation is not changed (Step S408; No), the immediately subsequent processing is skipped.

In a case where the delay time of late reverberation has been changed (Step S408; Yes), the sound producing device 100 adjusts the order of the early reflected sound so that the early reflected sound and the late reverberation sound do not excessively overlap (Step S409).

Furthermore, the sound producing device 100 determines whether or not the echo density of the late reverberation sound (corresponding to the parameter A10 illustrated in FIG. 14) has been changed in the late reverberation sound solver (Step S410). When the echo density of the late reverberation sound is not changed (Step S410; No), the immediately subsequent processing is skipped.

Since the echo density changes depending on the complexity of the object or the area to be processed, when the echo density of the late reverberation sound is changed (Step S410; Yes), the sound producing device 100 performs adjustment such as increasing the target area and the surface contributing to reflection in a pseudo manner (Step S411). Note that, although not illustrated in FIG. 18, even in a case where the other parameters are changed, the sound producing device 100 adjusts the parameters between the solvers and the environment data by performing the change according to the physical rule similarly to Step S409 and Step S411.

Then, the sound producing device 100 generates a signal in each of the solvers whose parameters have been changed (Step S412). Subsequently, the sound producing device 100 outputs a sound signal generated by combining the signals generated by the respective solvers (Step S413).

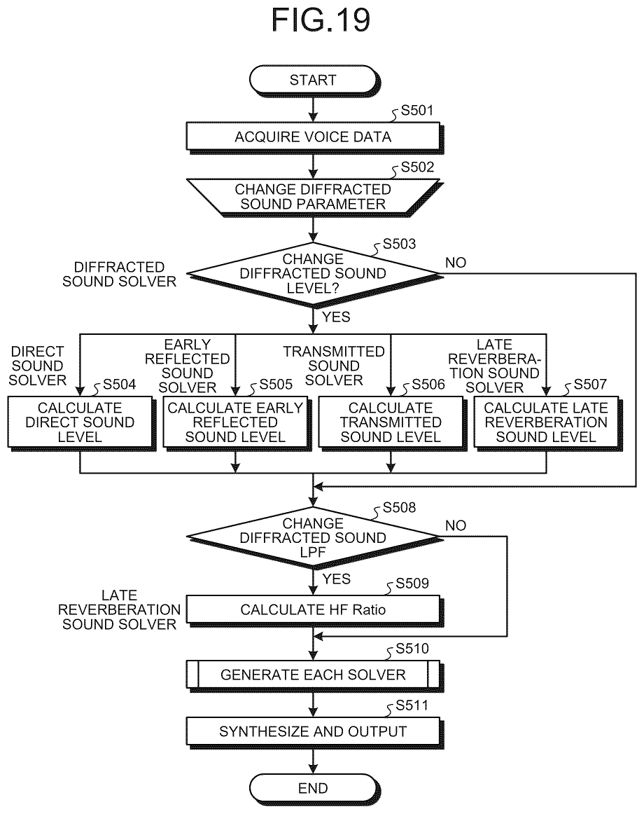

Next, a flow of processing in a case where the producer 200 changes the parameter of the diffracted sound will be described with reference to FIG. 19. FIG. 19 is a flowchart (3) illustrating an example of the flow of the change processing according to the embodiment.

First, the sound producing device 100 acquires voice data generated by the parameter before change (Step S501). Thereafter, some parameter changes regarding the diffracted sound are performed by the producer 200 (Step S502).

For example, the sound producing device 100 determines whether or not the diffracted sound level has been changed in the diffracted sound solver (Step S503). When the diffracted sound level is not changed (Step S503; No), the immediately subsequent processing is skipped.

When the diffracted sound level has been changed (Step S503; Yes), the sound producing device 100 performs level calculation so as to change the level also in the other solvers (Step S504, Step S505, Step S506, and Step S507). For example, the sound producing device 100 reflects, in each of the solvers, an increase or decrease in the level corresponding to the diffracted sound level in the parameters of each of the solvers.

Thereafter, the sound producing device 100 determines whether or not the setting of the low-pass filter of the diffracted sound has been changed in the diffracted sound solver (Step S508). For example, the sound producing device 100 determines whether or not the frequency, the order, and the like set in the low-pass filter have been changed. Additionally, when the setting of the low-pass filter for the diffracted sound is not changed (Step S508; No), the immediately subsequent processing is skipped.

When the setting of the low-pass filter for the diffracted sound has been changed (Step S508; Yes), the sound producing device 100 adjusts the ratio (HF Ratio) of the attenuation time of the high frequency to the attenuation time of the low frequency (parameter A09 illustrated in FIG. 14) in the late reverberation sound according to the physical rule (Step S509). In this case, the sound producing device 100 may recalculate the frequency dependence of the attenuation time in accordance with the change of the ratio. Note that, although not illustrated in FIG. 19, even in a case where the other parameters are changed, the sound producing device 100 adjusts the parameters between the solvers and the environment data by performing the change according to the physical rule similarly to Step S509.

Then, the sound producing device 100 generates a signal in each of the solvers whose parameters have been changed (Step S510). Subsequently, the sound producing device 100 outputs a sound signal generated by combining the signals generated by the respective solvers (Step S511).

Note that, although not illustrated, even in a case where the parameters of the transmitted sound solver are changed, the sound producing device 100 can readjust the parameters similarly to the processing illustrated in FIGS. 18 and 19.

### 1-4. Adjustment of Environment Data (Global Data)

In the above description, an example has been described in which when a parameter (local data) given to a certain solver is changed, the sound producing device 100 automatically adjusts a parameter of another solver. Here, in a case where a parameter given to a certain solver is changed, the sound producing device 100 may change the environment data originally given so as to make the sound after the change consistent in a case where the parameter given to the certain solver is changed.

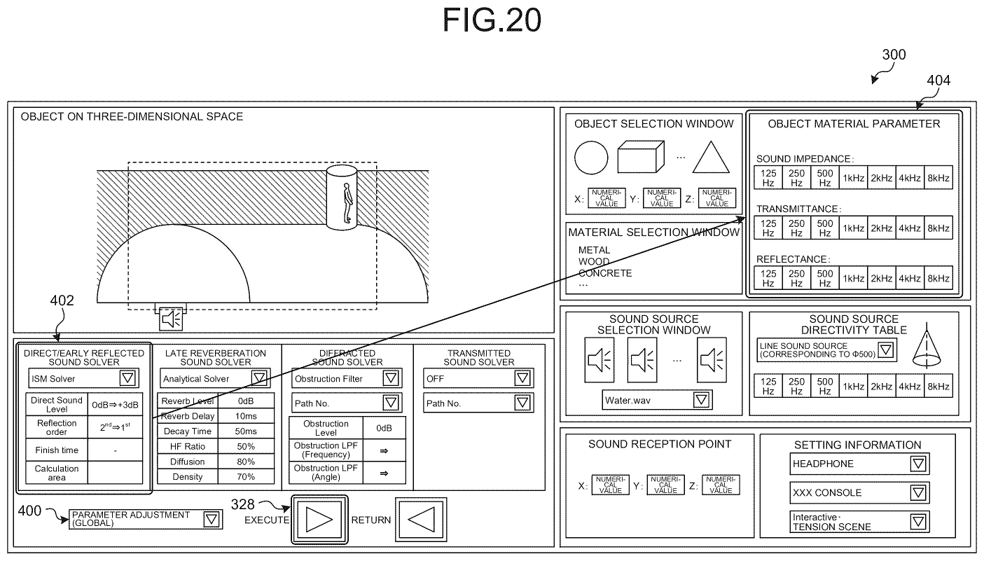

Such processing will be described with reference to FIG. 20. FIG. 20 is a diagram (8) for explaining the user interface of the sound simulation according to the embodiment.

In the example illustrated in FIG. 20, the producer 200 selects “parameter adjustment (global)” from a pull-down on the display 400. Such a change mode indicates that the environment data itself affecting the entire virtual space (global) is changed instead of adjustment between the solvers.

For example, the producer 200 changes the parameter of the early reflected sound to a desired value as illustrated in an early reflected sound parameter 402 after the change. Subsequently, the producer 200 presses the execution button 328.

In this case, the sound producing device 100 derives the original environment data so that the sound generated based on the early reflected sound parameter 402 after the change is realized. For example, the sound producing device 100 sets an object material parameter 404 in which the reflectance or the like set for the material of the object is changed, thereby realizing a sound that is generated based on the early reflected sound parameter 402 after the change and is not unnatural according to the physical rule.

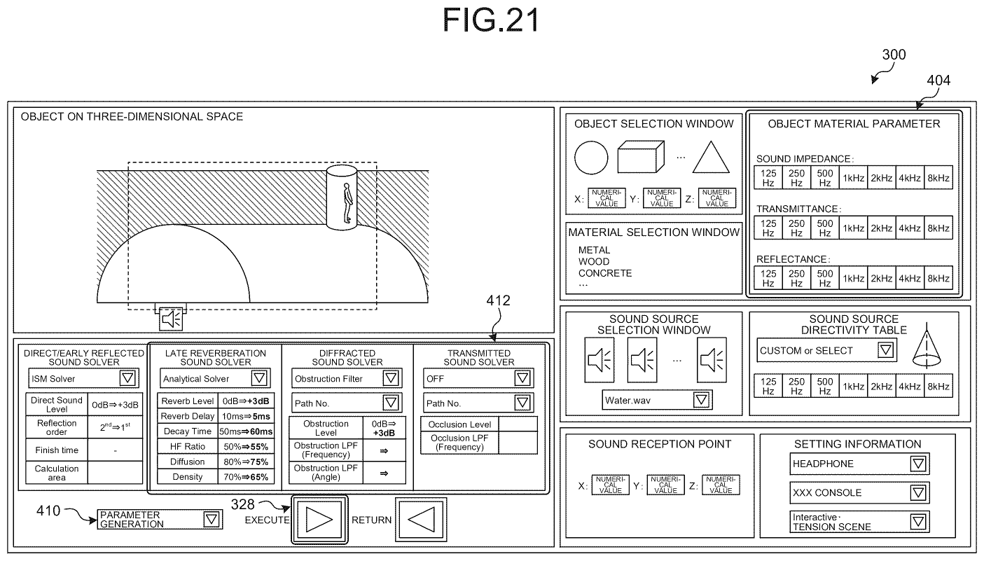

Note that, in a case where the reflectance of the material or the like is changed, the parameters of the respective solvers also change with the change, and thus, the sound producing device 100 recalculates the parameters. This point will be described with reference to FIG. 21. FIG. 21 is a diagram (9) for explaining the user interface of the sound simulation according to the embodiment.

As illustrated in FIG. 21, when the object material parameter 404 is changed, the producer 200 selects “parameter generation” from the pull-down of a display 410. In such a change mode, when the producer 200 presses the execution button 328, the sound producing device 100 generates parameters for respective solvers.

Specifically, the sound producing device 100 generates a parameter 412 after the change recalculated based on the object material parameter 404 after the change, and displays the parameter on the user interface 300. The producer 200 may further change the value of the parameter 412 after change if desired. In addition, in the “parameter adjustment (global)”, another solver parameter in which the target environment data is used can be recalculated retroactively, or can be reflected from a case where the same environment data is used after the next adjustment.

As described above, in a case where a certain parameter is changed, the sound producing device 100 can perform processing of automatically generating another parameter in consideration of an influence on another parameter, or automatically generating, from a predetermined impulse response, environment data (parameter) required for generating the impulse response by using an inverse calculation of a learned model as described later. Furthermore, the sound producing device 100 can more accurately handle a wave propagation phenomenon such as diffraction, and can change the transmittance, reflectance, and the like of the object according to the sound intended by the producer 200, for example.

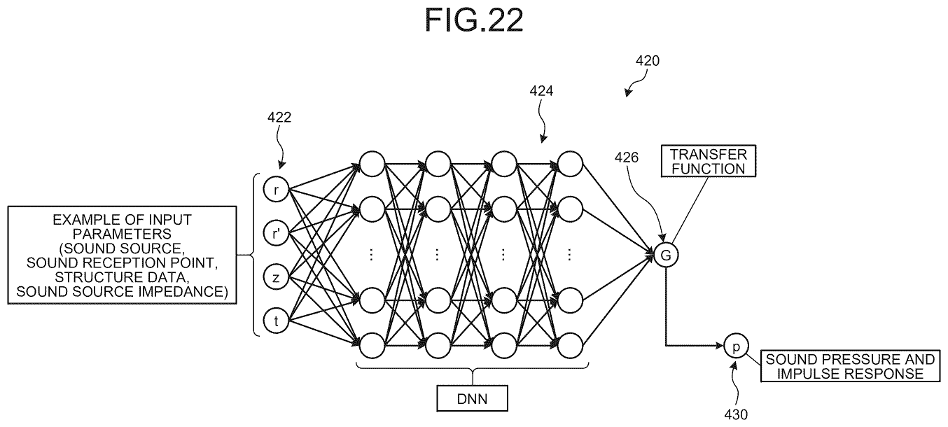

Such processing is realized, for example, by using a machine learning based wave sound simulation as illustrated in FIG. 22. FIG. 22 is a diagram for explaining an example of parameter control processing according to the embodiment.

FIG. 22 illustrates a model 420 which is an example of a calculator. The model 420 is an example of a calculator modeled through learning by deep learning (PINNs: also referred to as Physics Informed Neural Networks) satisfying the physical rule. By using the model 420, the sound producing device 100 can calculate the wave component of the sound at high speed without solving the wave equation in all spaces.

Note that, although details will be described later, in a case where a sound desired by the producer 200 or a combined output (in other words, information derived from the output of the model 420) as illustrated in the graph 60 of FIG. 1 is given, the sound producing device 100 can inversely calculate a sound source position and a boundary condition, which are input information to the simulator itself, using an inverse calculator of the model 420. That is, the sound producing device 100 corrects the input information using the inverse calculator and reproduces the parameters of the various generators 30 by the parameter controller 50 again, so that the parameters can be updated to parameters more suitable for the physical rule.

In the example illustrated in FIG. 22, it is assumed that the sound producing device 100 generates the model 420 based on predetermined learning data in advance. For example, the sound producing device 100 executes learning processing regarding the model 420 based on a condition given from the producer 200. The model 420 is a predetermined artificial intelligence, and is realized as a deep neural network (DNN) or an optional machine learning algorithm. For example, the model 420 includes a DNN 424 for realizing the PINNs described above.

The model 420 is a system generated by learning processing so as to input various types of data (data set) as training data and output a transfer function 426 which is a transfer function at a sound source and a sound reception point. The transfer function 426 is, for example, a Green's function used to calculate the impulse response and the sound pressure 430 at the sound reception point using predetermined function conversion. That is, the model 420 is an artificial intelligence model generated to receive data of various parameters including environment data as an input and output the transfer function 426 as an output. The sound producing device 100 uses, for example, an actual measurement value or the like simulated using the FDTD method or the like in a learning environment (in the embodiment, a predetermined virtual space as a processing target) as training data, and performs learning processing of the model 420 so as to output a parameter of the transfer function 426 by a method of minimizing an error between a value output from the model 420 and training data for presenting the value to be output. The transfer function 426 defines a shape of a function curve of an impulse response based on a predetermined input. That is, in the model 420, for example, the output of n nodes arranged in a layer immediately before a node G that is the Green function can be complemented with the curve as n sample points in a time axis direction of the impulse response to generate the Green function curve. At this time, the sound producing device 100 can perform learning by minimizing an error between the curve shape of the training model and each sample point.

The input information 422 to the model 420 is a data set including sound source information, sound reception point information, environment data regarding a structure constituting a space, and data such as boundary conditions such as sound impedance of the structure. Among the input information 422, the input data of the model 420 includes, for example, coordinate data of a structure constituting the virtual space, coordinate data of a sound reception point (corresponding to “r” illustrated in FIG. 22), sound source information (corresponding to “r′” illustrated in FIG. 22), and a boundary condition (corresponding to “z” illustrated in FIG. 1) such as sound impedance of a structure or an object constituting the virtual space. Furthermore, since the output of the transfer function 426 formed in the output layer of the model 420 generated by the learning processing obtains the impulse response of the sound reception point at “optional time”, the input data of the model 420 in the input information 422 may include a parameter indicating time (corresponding to “t” illustrated in FIG. 1).

For example, the sound producing device 100 learns the model 420 so as to generate learning data by variously changing conditions such as data regarding the structure of the virtual space, sound impedance, position data of the sound source and the sound reception point, and the size of the sound source given from the producer 200 or the like, and to generate a predetermined impulse response based on the generated learning data. As a result, the sound producing device 100 generates the model 420 that can output the impulse response of the transfer function 426 suitable for the predetermined virtual space by the learning processing. Note that, since the sound pressure can be derived from the transfer function 426 formed in the output layer of the model 420 using predetermined function conversion, for example, the sound pressure at the sound reception point can be obtained using the model 420. As a result, the sound producing device 100 can reproduce the sound in a case where the sound emitted from the sound source is heard at the sound reception point with high accuracy.

As described above, the data set used as the input of the model 420 includes the coordinate data of the sound reception point and the sound source and the time data as parameters. Furthermore, the model 420 is configured by, for example, a DNN, and specifically, is learned such that the output of the transfer function 426 formed in the final output layer of the DNN forms an impulse response curve. Further, the sound pressure can be calculated by function conversion based on the Green's function output of the model 420. Therefore, the sound producing device 100 can indicate a sound emitted by a certain sound source as a spatial distribution. Furthermore, since the input of the model 420 includes time as a parameter, it is also possible to express the propagation of the sound emitted from the sound source in time series. In the embodiment, the model 420 learns a relationship of combinations of “r”, “r′”, “t”, and “z” illustrated in FIG. 22. Note that it is basic to have “r”, “r′”, and “t” as parameters as the Green function, but the sound producing device 100 can generate the Green function having various parameters, that is, the transfer function 426 as the learning model by setting a sound impedance z which is the parameter illustrated in FIG. 22 and other boundary conditions (for example, the shape of the object and the like) as the parameters of the input data set. Therefore, there is an effect that the sound producing device 100 can automatically generate, by learning, a green function including a large number of parameters that have been difficult to design a known algorithm. The Green's function is, for example, a function representing an impulse response. When the impulse response of the sound reception point is known, the sound pressure (in other words, the loudness of the sound) at the sound reception point can also be obtained analytically.

The model 420 generated as described above corresponds to the simulation model 52 of an example of the parameter controller 50 illustrated in FIG. 2.

For example, it is assumed that the producer 200 performs waveform editing and the like on the first sound signal generated first. In this case, the sound producing device 100 acquires the sound signal in which the impulse response, the sound pressure, and the like at the sound reception point are changed. Since this corresponds to a change in the sound signal output of the model 420, the sound producing device 100 inputs the changed impulse response to the output side (output layer) of the model 420, and can calculate the sound source position and the boundary condition, which are the input information 422 to the model 420, by using an inverse calculation of the model 420 that performs calculation to obtain an output from the input side (input layer) of the model 420. Specifically, the sound producing device 100 can change a parameter of sound characteristics such as transmittance of a structure of a space or automatically change and set a parameter that defines a shape, a position, or the like of an object arranged in the space so that a sound (a sound signal having a predetermined impulse response or the like) changed by the producer 200 is output.

As described above, when receiving the change request for the first sound signal, the sound producing device 100 inputs information (impulse response or the like) corresponding to the changed sound signal to the sound simulator modeled by the learning of the artificial intelligence, and performs an inverse calculation from the output side to the input side of the learned model, thereby reflecting data output from the input side of the learned model as the environment data after adjustment. In this case, the artificial intelligence can be configured by a deep neural network, and the information (data) output based on the inverse calculation of the deep neural network is reflected in the environment data, that is, the output data is set as the adjusted environment data. As the environment data, the sound producing device 100 reflects, for example, a change in at least one of a material, a transmittance, a reflectance, position data, and a shape of a structure constituting a space including a sound source and a sound reception point or of an object arranged in the space.

As described above, according to the sound producing device 100, the producer 200 can acquire the setting (environment data) of the compatible virtual space also by a method of directly editing the waveform of the desired sound without manually changing the parameter of the solver. In other words, the producer 200 can easily construct a virtual space along a desired sound and easily execute arrangement of objects in conformity with the sound environment of the real space.

### 1-5. Learning Processing by Scene Setting

Furthermore, the sound producing device 100 may automatically set the parameter by inputting predetermined scene data to the learned model and outputting a parameter to be set using a learning method of performing learning processing on a parameter change tendency by the user for each scene setting.

As described above, the producer 200 can select a scene setting at the time of sound design in the virtual space. For example, the producer 200 can set, for each scene to be edited, whether the scene is a “tense scene”, a “normal scene”, a “battle scene”, or the like.

In the sound design, depending on the scene, there may be a tendency for the producer 200 to change the sound. For example, the sound producing device 100 acquires each change result such that the producer 200 tends to lower the level or the order of the early reflected sound in the case of the “tense scene”, or the producer 200 tends to shorten the reverberation time of the late reverberation in the case of the “battle scene”.

Then, the sound producing device 100 learns the tendency of these changes using a predetermined learning method (for example, reinforcement learning or the like) as described above. That is, the sound producing device 100 inputs data designating a scene to the learning model, outputs a parameter such as a sound characteristic as an output thereof, and does not perform learning in a case where the user does not change the parameter for the output. On the other hand, in a case where the user has changed the parameter, the sound producing device 100 can generate a model that has learned the parameter change tendency of the user by using a method for learning to correct the network. As a result, when scene setting is performed in advance at the time of first generating the parameter (local data) of each solver, the sound producing device 100 can adjust the parameter based on the local data related to the scene setting. That is, the sound producing device 100 learns the artificial intelligence model by using the data of the correlation in which the producer 200 manually adjusts the parameter (local data) of the solver according to the scene as the learning data, so that the parameter controller 50 can automatically generate the parameter (local data) close to the intention of the producer 200 according to the change in the scene using the learned model. As a result, the producer 200 can more smoothly perform the sound design work. Note that the sound producing device 100 may learn the correlation between the scene and the parameter for each producer 200, or may collectively learn the correlation between the scene and the parameter for a plurality of producers 200.

### 1-6. Modification According to Embodiment

The information processing according to the embodiment described above may be accompanied by various modifications. Hereinafter, modifications of the embodiment will be described.

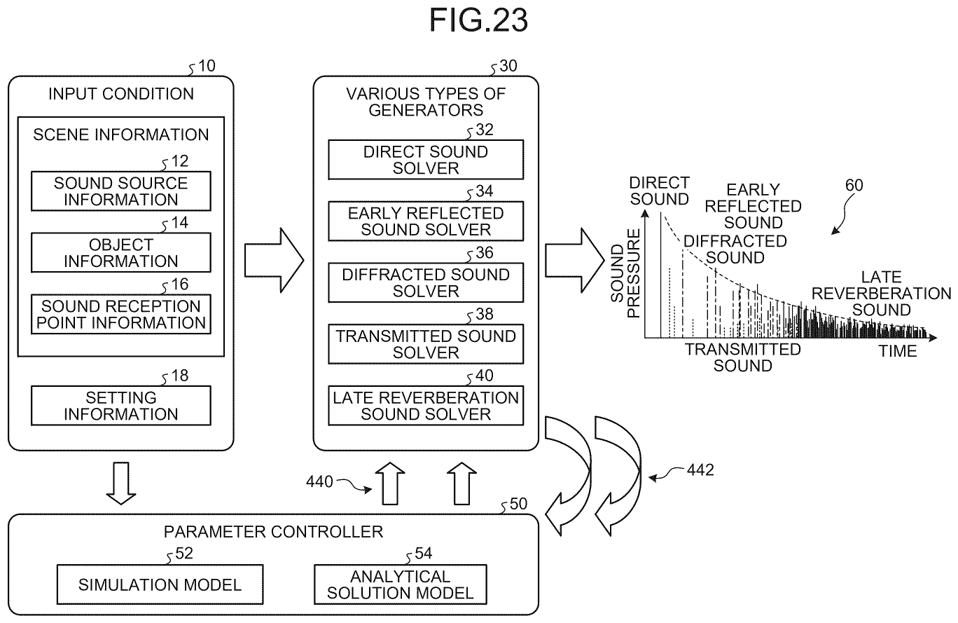

FIG. 23 is a diagram illustrating an outline of a sound generation control method according to a modification. In the example of FIG. 23, it is assumed that the parameter controller 50 transmits different parameters using a plurality of transmission paths as illustrated as a transmission path 440 and a transmission path 442.

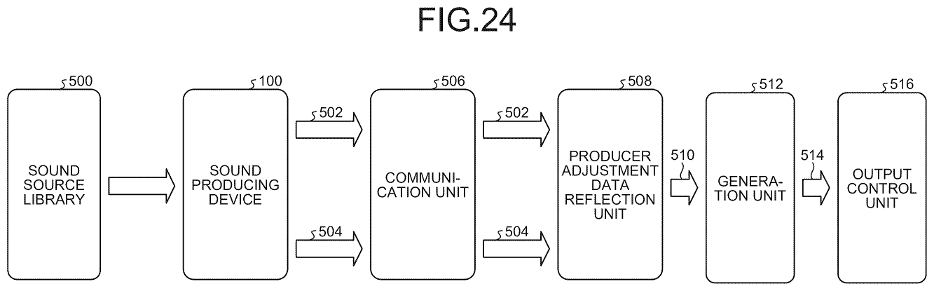

An execution example based on such transmission is illustrated in FIG. 24. FIG. 24 is a diagram illustrating an example of output control processing according to a modification.

In the example of FIG. 24, when a sound source is selected from a sound source library 500, the sound producing device 100 performs parameter generation by the parameter controller 50 based on the selected sound source. Furthermore, the sound producing device 100 also stores parameters reproduced based on the parameters changed by the producer 200.

Thereafter, the sound producing device 100 transmits an early parameter 502 generated by the parameter controller 50 and a second parameter 504 adjusted by the producer 200 to a communication unit 506 in different systems.

The communication unit 506 transmits the early parameter 502 and the second parameter 504 to a producer adjustment data reflection unit 508 (external device or the like) in different systems. At this time, the behavior of the producer adjustment data reflection unit 508 is different between the developer side (including the producer 200) and the general user side using the content. For example, the developer side can readjust the parameter based on the received early parameter 502 and second parameter 504. On the other hand, the general user side is set so that the parameters cannot be adjusted in the producer adjustment data reflection unit 508, and the data output from a generation unit 512 in the subsequent stage is uniquely determined. Note that the sound producing device 100 may have a mechanism for encrypting the early parameter 502 and the producer adjustment data reflection unit 508 and protecting the adjustment technique or the like of the producer from a person other than a limited developer.

The producer adjustment data reflection unit 508 transmits a data 510 obtained through one of the above sides to the generation unit 512. The generation unit 512 generates sound data 514 based on the received data 510 (parameters adjusted by the developer or parameters transmitted to general users). Then, an output control unit 516 receives the sound data 514 generated by the generation unit 512 and outputs a voice corresponding to the sound data 514.

As described above, the sound producing device 100 may perform control to transmit the first parameter or the first sound signal based on the first parameter and the adjusted second parameter or the second sound signal based on the second parameter separately.

As described above, the sound producing device 100 can select the method of using the parameter according to the application of the developer (the producer 200 or the like) or the general user by using a plurality of transmission paths. That is, when transmitting the generated parameter, the sound producing device 100 can change its behavior depending on the application according to whether it is for a developer or for a general user. As a result, the developer can flexibly edit the parameters, such as returning the parameters to the standard parameters (early parameters) even after the parameter adjustment.

### 2. Other Embodiments

The processing according to each embodiment described above may be performed in various different modes other than each embodiment described above.

Among the processes described in each of the above embodiments, all or a part of the processes described as being performed automatically can be performed manually, or all or a part of the processes described as being performed manually can be performed automatically by a known method. In addition, the processing procedure, specific name, and information including various types of data and parameters illustrated in the document and the drawings can be optionally changed unless otherwise specified. For example, the various types of information illustrated in each drawing are not limited to the illustrated information.

In addition, each component of each device illustrated in the drawings is functionally conceptual, and is not necessarily physically configured as illustrated in the drawings. That is, a specific form of distribution and integration of each device is not limited to the illustrated form, and all or a part thereof can be configured to be functionally or physically distributed and integrated in an optional unit according to various loads, usage conditions, and the like.

In addition, the above-described embodiments and modifications can be appropriately combined within a range that does not contradict processing contents.

Further, the effects described in the present specification are merely examples and are not limited, and other effects may be provided.

### 3. Effects of Sound Generation Control Method According to the Present Disclosure

As described above, in the sound generation control method according to the present disclosure, the computer (the sound producing device 100 in the embodiment) receives an input of environment data indicating each condition set in the virtual space in which the sound source and the sound reception point are arranged. Further, the computer not only selects a plurality of solvers for calculating the characteristics of the sound at the sound reception point according to the environment data, but also determines the first parameter to be input to each of the plurality of solvers. Furthermore, the computer receives a change request for the first sound signal generated based on the first parameter. In addition, the computer automatically adjusts the environment data or the first parameter in response to the change request, and generates the second sound signal using the adjusted environment data or the second parameter that is the adjusted parameter and is newly input to each of the solvers.

As described above, the sound generation control method according to the present disclosure automatically selects a plurality of solvers to be used for generating a sound signal, determines parameters thereof, and automatically adjusts other related parameters so as to follow a predetermined physical rule when there is a request to change the parameters. As a result, the sound generation control method can newly generate a sound signal without unnaturalness as a whole. That is, according to the sound generation control method according to the present disclosure, it is possible to reduce the work load of the producer 200 and generate a consistent sound signal.

In addition, in the sound generation control method, when a change request for the first sound signal is received by changing the first parameter input to the predetermined solver, the parameter input to the other solver is changed to the second parameter according to the parameter changed in the predetermined solver, and the second sound signal is generated using the second parameter. Further, each of the plurality of solvers is associated with the calculation of the characteristics of each of the direct sound, the early reflected sound, the diffracted sound, the transmitted sound, and the late reverberation sound of the sounds at the sound reception point. In the sound generation control method, in a case where any one of the first parameters input to the solver corresponding to any one of the direct sound, the early reflected sound, the diffracted sound, the transmitted sound, and the late reverberation sound is changed, the generation unit changes the parameter input to the other solver to the second parameter according to the physical rule between the changed solver and the other solver. For example, the physical rule is based on an analytical solution by a theoretical formula or based on a wave sound simulator that predicts a sound field in a virtual space.

As described above, according to the sound generation control method, parameter change with physical consistency can be realized by changing the parameter in consideration of the influence between the parameters.

Further, in the sound generation control method, it is selected whether or not to be used as a solver that generates a first sound signal or a second sound signal among the plurality of solvers according to the environment data. For example, in the sound generation control method, it is selected, from the environment data, whether or not the space to be a processing target is closed, whether or not there is a geometric obstacle between the sound source and the sound reception point, or whether or not the sound source and the sound reception point are used as a solver that generates the first sound signal or the second sound signal among the plurality of solvers based on a transmission loss between the sound source and the sound reception point.

As described above, according to the sound generation control method, since an appropriate solver is selected based on the environment data input by the producer, the producer can determine a solver for generating an appropriate sound without manually performing setting or the like.

Furthermore, in the sound generation control method, the environment data is data designating a scene set in the virtual space, and the sound generation control method determines the first parameter based on the designated scene.

As described above, according to the sound generation control method, the parameter change according to the producer's intention can be realized by learning the change performed in the state where the scene is set.

Furthermore, in a case where a change request for the first sound signal is received, the sound generation control method inputs information corresponding to the changed sound signal to the sound simulator modeled by artificial intelligence, and reflects the output information as the adjusted environment data. At this time, the artificial intelligence is a learned deep neural network, and information (data) output based on the inverse calculation of the deep neural network can be set as the adjusted environment data. The sound generation control method includes reflecting, as the adjusted environment data, a change in at least one of a material, a transmittance, a reflectance, position data, and a shape of a structure constituting a space including a sound source and a sound reception point or of an object arranged in the space.

As described above, according to the sound generation control method, the environment data (the shape of the structure of the space, or the like) for realizing the sound environment in the virtual space can be obtained by inverse calculation by using the simulator generated by the machine learning. As a result, the producer can arrange the object and select the material of the object consistent with the realistic sound environment without being particularly conscious.

In addition, the sound generation control method performs control to transmit the first parameter or the first sound signal based on the first parameter and the adjusted second parameter or the second sound signal based on the second parameter separately.

As described above, according to the sound generation control method, it is possible to flexibly utilize the parameters after adjustment by separately transmitting the generated parameters for producer and general user, for example.

In addition, the sound generation control method includes switchably outputting the first sound signal based on the first parameter and the second sound signal based on the second parameter according to the operation of the operator (the producer 200 in the embodiment) on the user interface.

As described above, according to the sound generation control method, since the producer can easily confirm the sounds before and after the change, the sound design work can be smoothly advanced.

### 4. Hardware Configuration

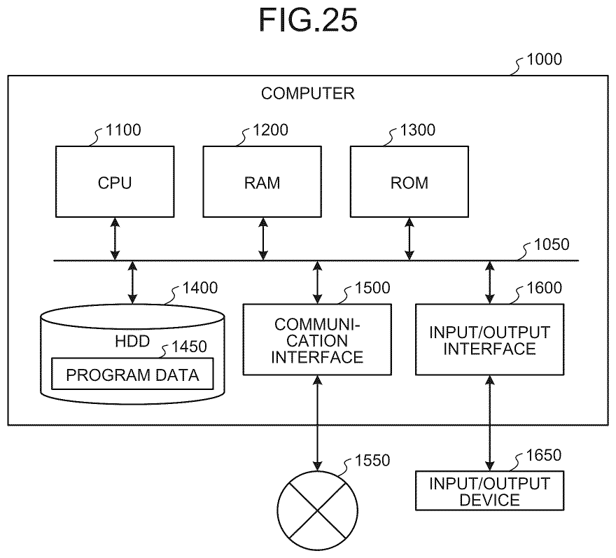

The information device such as the sound producing device 100 according to each embodiment described above is realized by a computer 1000 having a configuration as illustrated in FIG. 25, for example. Hereinafter, the sound producing device 100 according to the embodiment will be described as an example. FIG. 25 is a hardware configuration diagram illustrating an example of the computer 1000 that implements functions of the sound producing device 100. The computer 1000 includes a CPU 1100, a RAM 1200, a read only memory (ROM) 1300, a hard disk drive (HDD) 1400, a communication interface 1500, and an input/output interface 1600. Each unit of the computer 1000 is connected by a bus 1050.

The CPU 1100 operates based on a program stored in the ROM 1300 or the HDD 1400, and controls each unit. For example, the CPU 1100 develops a program stored in the ROM 1300 or the HDD 1400 in the RAM 1200, and executes processing corresponding to various programs.

The ROM 1300 stores a boot program such as a Basic Input Output System (BIOS) executed by the CPU 1100 when the computer 1000 is activated, a program depending on hardware of the computer 1000, and the like.

The HDD 1400 is a computer-readable recording medium that non-transiently records a program executed by the CPU 1100, data used by the program, and the like. Specifically, the HDD 1400 is a recording medium that records an information processing program according to the present disclosure as an example of program data 1450.

The communication interface 1500 is an interface for the computer 1000 to connect to an external network 1550 (for example, the Internet). For example, the CPU 1100 receives data from another device or transmits data generated by the CPU 1100 to another device via the communication interface 1500.

The input/output interface 1600 is an interface for connecting an input/output device 1650 and the computer 1000. For example, the CPU 1100 receives data from an input device such as a touch panel, a keyboard, a mouse, a microphone, or a camera via the input/output interface 1600. In addition, the CPU 1100 transmits data to an output device such as a display, a speaker, or a printer via the input/output interface 1600. Furthermore, the input/output interface 1600 may function as a media interface that reads a program or the like recorded in a predetermined recording medium (media). Examples of the media include an optical recording medium such as a digital versatile disc (DVD) or a phase change rewritable disk (PD), a magneto-optical recording medium such as a magneto-optical disk (MO), a tape medium, a magnetic recording medium, and a semiconductor memory.

For example, in a case where the computer 1000 functions as the sound producing device 100 according to the embodiment, the CPU 1100 of the computer 1000 realizes the functions of the control unit 130 and the like by executing the information processing program loaded on the RAM 1200. In addition, the HDD 1400 stores a sound generation control program according to the present disclosure and data in the storage unit 120. Note that the CPU 1100 reads the program data 1450 from the HDD 1400 and executes the program data, but as another example, these programs may be acquired from another device via the external network 1550.

Note that the present technology can also have the following configurations.

(1) A Sound Generation Control Method Comprising:
causing a computer to execute
receiving an input of environment data indicating each condition set in a virtual space in which a sound source and a sound reception point are arranged;
selecting a plurality of solvers for calculating characteristics of a sound at the sound reception point in accordance with the environment data, and determining a first parameter to be input to each of the plurality of solvers;
receiving a change request for a first sound signal generated based one the first parameter; and
adjusting the environment data or the first parameter in response to the change request, and generating a second sound signal using the adjusted environment data or a second parameter that is the adjusted parameter and is newly input to each of the solvers.

(2) The sound generation control method according to (1), wherein when a change request for the first sound signal is received by changing the first parameter input to the predetermined solver, the parameter input to the other solver is changed to the second parameter according to the parameter changed in the predetermined solver, and the second sound signal is generated using the second parameter.

(3) The sound generation control method according to (2), wherein each of the plurality of solvers is associated with calculation of characteristics of each of a direct sound, an early reflected sound, a diffracted sound, a transmitted sound, and a late reverberation sound of the sounds at the sound reception point.

(4) The sound generation control method according to (3), wherein in a case where any one of the first parameters input to the solver corresponding to any one of the direct sound, the early reflected sound, the diffracted sound, the transmitted sound, and the late reverberation sound is changed, the generation unit changes the parameter input to the other solver to the second parameter according to a physical rule between the changed solver and the other solver.

(5) The sound generation control method according to (4), wherein the physical rule is based on an analytical solution by a theoretical formula.

(6) The sound generation control method according to (4), wherein the physical rule is based on a wave sound simulator that predicts a sound field of the virtual space.

(7) The sound generation control method according to any one of (1) to (6), wherein it is selected whether or not to be used as a solver that generates the first sound signal or the second sound signal among the plurality of solvers according to the environment data.

(8) The sound generation control method according to (7), wherein it is selected, from the environment data, whether or not a space to be a processing target is closed, whether or not there is a geometric obstacle between the sound source and the sound reception point, or whether or not the sound source and the sound reception point are used as a solver that generates the first sound signal or the second sound signal among the plurality of solvers based on a transmission loss between the sound source and the sound reception point.

(9) The sound generation control method according to any one of (1) to (8), wherein the environment data is data designating a scene set in the virtual space, and
the sound generation control method determines the first parameter based on the designated scene.

(10) The sound generation control method according to any one of (1) to (9), wherein in a case where a change request for the first sound signal is received, the sound generation control method inputs information corresponding to the changed sound signal to the sound simulator modeled by artificial intelligence, and reflects the output information as the adjusted environment data.

(11) The sound generation control method according to (10), wherein the artificial intelligence is a deep neural network, and adjusts the environment data based on an inverse calculation of the deep neural network.

(12) The sound generation control method according to (10) or (11), further comprising: reflecting, as the adjusted environment data, a change in at least one of a material, a transmittance, a reflectance, position data, and a shape of a structure constituting a space including a sound source and a sound reception point or of an object arranged in the space.

(13) The sound generation control method according to any one of (1) to (12), further comprising: performing control to transmit the first parameter or the first sound signal based on the first parameter and the adjusted second parameter or the second sound signal based on the second parameter separately.

(14) The sound generation control method according to any one of (1) to (13), further comprising: switchably outputting the first sound signal based on the first parameter and the second sound signal based on the second parameter according to the operation of the operator on the user interface.

(15) A sound producing device comprising:
an input unit that receives an input of environment data indicating each condition set in a virtual space in which a sound source and a sound reception point are arranged; and
a generation unit that selects a plurality of solvers for calculating characteristics of a sound at the sound reception point in accordance with the environment data, and determines a first parameter to be input to each of the plurality of solvers to generate a first sound signal based on the determined first parameter,
wherein when receiving a change request for the first sound signal, the generation unit adjusts the environment data or the first parameter in response to the change request, and generates a second sound signal using the adjusted environment data or a second parameter that is the adjusted parameter and is newly input to each of the solvers.

(16) A sound generation control program causing a computer to function as:
an input unit that receives an input of environment data indicating each condition set in a virtual space in which a sound source and a sound reception point are arranged; and
a generation unit that selects a plurality of solvers for calculating characteristics of a sound at the sound reception point in accordance with the environment data, and determines a first parameter to be input to each of the plurality of solvers to generate a first sound signal based on the determined first parameter,
wherein when receiving a change request for the first sound signal, the generation unit adjusts the environment data or the first parameter in response to the change request, and generates a second sound signal using the adjusted environment data or a second parameter that is the adjusted parameter and is newly input to each of the solvers.

### REFERENCE SIGNS LIST

100 SOUND PRODUCING DEVICE
110 COMMUNICATION UNIT
120 STORAGE UNIT
130 CONTROL UNIT
131 ACQUISITION UNIT
132 DISPLAY CONTROL UNIT
133 INPUT UNIT
134 GENERATION UNIT
135 OUTPUT CONTROL UNIT
140 OUTPUT UNIT
150 DISPLAY
160 SPEAKER
200 PRODUCER

1. A sound generation control method comprising:
causing a computer to execute
receiving an input of environment data indicating each condition set in a virtual space in which a sound source and a sound reception point are arranged;
selecting a plurality of solvers for calculating characteristics of a sound at the sound reception point in accordance with the environment data, and determining a first parameter to be input to each of the plurality of solvers;
receiving a change request for a first sound signal generated based one the first parameter; and
adjusting the environment data or the first parameter in response to the change request, and generating a second sound signal using the adjusted environment data or a second parameter that is the adjusted parameter and is newly input to each of the solvers.

2. The sound generation control method according to claim 1, wherein when a change request for the first sound signal is received by changing the first parameter input to the predetermined solver, the parameter input to the other solver is changed to the second parameter according to the parameter changed in the predetermined solver, and the second sound signal is generated using the second parameter.

3. The sound generation control method according to claim 2, wherein each of the plurality of solvers is associated with calculation of characteristics of each of a direct sound, an early reflected sound, a diffracted sound, a transmitted sound, and a late reverberation sound of the sounds at the sound reception point.

4. The sound generation control method according to claim 3, wherein in a case where any one of the first parameters input to the solver corresponding to any one of the direct sound, the early reflected sound, the diffracted sound, the transmitted sound, and the late reverberation sound is changed, the generation unit changes the parameter input to the other solver to the second parameter according to a physical rule between the changed solver and the other solver.

5. The sound generation control method according to claim 4, wherein the physical rule is based on an analytical solution by a theoretical formula.

6. The sound generation control method according to claim 4, wherein the physical rule is based on a wave sound simulator that predicts a sound field of the virtual space.

7. The sound generation control method according to claim 1, wherein it is selected whether or not to be used as a solver that generates the first sound signal or the second sound signal among the plurality of solvers according to the environment data.

8. The sound generation control method according to claim 7, wherein it is selected, from the environment data, whether or not a space to be a processing target is closed, whether or not there is a geometric obstacle between the sound source and the sound reception point, or whether or not the sound source and the sound reception point are used as a solver that generates the first sound signal or the second sound signal among the plurality of solvers based on a transmission loss between the sound source and the sound reception point.

9. The sound generation control method according to claim 1, wherein the environment data is data designating a scene set in the virtual space, and
the sound generation control method determines the first parameter based on the designated scene.

10. The sound generation control method according to claim 1, wherein in a case where a change request for the first sound signal is received, the sound generation control method inputs information corresponding to the changed sound signal to the sound simulator modeled by artificial intelligence, and reflects the output information as the adjusted environment data.

11. The sound generation control method according to claim 10, wherein the artificial intelligence is a deep neural network, and adjusts the environment data based on an inverse calculation of the deep neural network.

12. The sound generation control method according to claim 10, further comprising: reflecting, as the adjusted environment data, a change in at least one of a material, a transmittance, a reflectance, position data, and a shape of a structure constituting a space including a sound source and a sound reception point or of an object arranged in the space.

13. The sound generation control method according to claim 1, further comprising: performing control to transmit the first parameter or the first sound signal based on the first parameter and the adjusted second parameter or the second sound signal based on the second parameter separately.

14. The sound generation control method according to claim 1, further comprising: switchably outputting the first sound signal based on the first parameter and the second sound signal based on the second parameter according to the operation of the operator on the user interface.

15. A sound producing device comprising:
an input unit that receives an input of environment data indicating each condition set in a virtual space in which a sound source and a sound reception point are arranged; and
a generation unit that selects a plurality of solvers for calculating characteristics of a sound at the sound reception point in accordance with the environment data, and determines a first parameter to be input to each of the plurality of solvers to generate a first sound signal based on the determined first parameter,
wherein when receiving a change request for the first sound signal, the generation unit adjusts the environment data or the first parameter in response to the change request, and generates a second sound signal using the adjusted environment data or a second parameter that is the adjusted parameter and is newly input to each of the solvers.

16. A sound generation control program causing a computer to function as:
an input unit that receives an input of environment data indicating each condition set in a virtual space in which a sound source and a sound reception point are arranged; and
a generation unit that selects a plurality of solvers for calculating characteristics of a sound at the sound reception point in accordance with the environment data, and determines a first parameter to be input to each of the plurality of solvers to generate a first sound signal based on the determined first parameter,
wherein when receiving a change request for the first sound signal, the generation unit adjusts the environment data or the first parameter in response to the change request, and generates a second sound signal using the adjusted environment data or a second parameter that is the adjusted parameter and is newly input to each of the solvers.
